(19) United States
(12) Patent Application Publication
(10) Pub. No.: US 2021/0032116 A1
(43) Pub. Date: Feb. 4, 2021

(54) ELECTROCATALYSTS, THE PREPARATION THEREOF, AND USING THE SAME FOR AMMONIA SYNTHESIS

(71) Applicant: ARIEL SCIENTIFIC INNOVATIONS LTD., Ariel (IL)

(72) Inventors: Alex SCHECHTER, Givat Koach (IL); Manjunatha REVANASIDDAPPA, Karnataka (IN); Valentina GOLDSHTEIN, Petah Tikva (IL); Aleksandar KARAJIC, Cacak (RS)

(21) Appl. No.: 17/043,884

(22) PCT Filed: Apr. 2, 2019
(86) PCT No.: PCT/IL2019/050384

§ 371 Date: Sep. 30, 2020

Related U.S. Application Data
(60) Provisional application No. 62/651,310, filed on Apr. 2, 2018.
(60) Provisional application No. 62/731,992, filed on Sep. 17, 2018.

(51) Int. Cl. C01C 1/04; B01J 21/18; B01J 23/28; B01J 23/652; B01J 23/745; B01J 23/75; B01J 23/755; B01J 23/881; H01M 4/90; B01J 35/02

(52) U.S. Cl. CPC C01C 1/0411; B01J 21/18; B01J 23/28; B01J 23/652; B01J 35/023; B01J 23/75; B01J 23/755; B01J 23/881; H01M 4/90; B01J 23/745

(57) ABSTRACT

Compositions comprising a first metal component and a second metal component wherein the molar ratio of the first metal component to the second metal component is in the range of 1:9 to 9:1, respectively, and wherein a surface of the second metal component is coated with the first metal component, is disclosed. Uses the compositions as catalysts are further disclosed. Electrochemical cells containing the compositions are further disclosed. A process of synthesizing ammonia using the compositions is further disclosed.

### CROSS REFERENCE TO RELATED APPLICATIONS

This application claims the benefit of priority to U.S. Provisional Patent Application No. 62/651,310 filed Apr. 2, 2018, entitled “ELECTROCATALYSTS, THE PREPARATION THEREOF, AND USING THE SAME FOR AMMONIA SYNTHESIS” and U.S. Provisional Patent Application No. 62/731,992 filed Sep. 17, 2018, entitled “ELECTROCHEMICAL AMMONIA GENERATION DIRECTLY FROM NITROGEN AND AIR USING IRON-OXIDE/TITANIA BASED CATALYST AT AMBIENT CONDITIONS”, the contents of which are incorporated herein by reference in their entirety.

### FIELD OF INVENTION

The present invention, in some embodiments thereof, relates to metal based catalysts and uses thereof for, e.g., ammonia synthesis.

### BACKGROUND OF THE INVENTION

The ammonia is extensively produced by using Haber-Bosch process developed in nineteenth century which requires very high pressure and temperature. Industries produce annually more than 200 million tons of ammonia from this method and majority of it used for production of fertilizers. The hydrogen required for this process is generated from steam regeneration, which consumes three to five percent of total natural gas production and releases huge quantity of greenhouse carbon dioxide gas to atmosphere.

Therefore, alternative greener, energy efficient and mild conditional ammonia synthesis is one of the major global challenges. The major bottle neck in ammonia synthesis is dissociation of inert di-nitrogen molecule on catalyst surface and subsequent nitrogen reduction reaction (NRR).

### SUMMARY OF THE INVENTION

According to an aspect of some embodiments of the present invention there is provided a composition comprising a first metal component comprising one or more metals and a second metal component comprising one or more metals, wherein: (i) at least one surface of the second metal component is coated with the first metal component; (ii) the molar ratio of the first metal component to the second metal component are in the range of 1:9 to 9:1, and (iii) the composition is in the form of particles.

In some embodiments, the particles have a size in the range of 1 nm to 50 μm.

In some embodiments, the first metal component and/or second metal component comprise two metals.

In some embodiments, the first metal component comprises Fe, Ru, Pt, Pd, Sn, Co, Mo, and any combination thereof.

In some embodiments, the second metal component comprises Ti, Sn, Ru, Fe, Pt, Pb, Bi, Hg, Cd, and any combination thereof.

In some embodiments, the first metal component is Fe₂O₃ or Fe₃O₄ or Fe₂O₃FeO and the second metal component is TiO₂.

In some embodiments, the first metal component is Fe and the second metal component is Sn.

In some embodiments, the first metal component is Ru or Fe and the second metal component is Pt or Pd or Sn.

In some embodiments, the first metal component is Pt and the second metal component is Ru.

In some embodiments, the composition further comprises a substrate, wherein the first metal component and the second metal component are deposited on at least one surface of the substrate.

In some embodiments, the substrate is selected from the group consisting of: carbon black, activated carbon, graphite, carbon nanotube, and any combination thereof.

In some embodiments, the carbon black is selected from the group consisting of: carbon nanotube, graphene, Vulcan XC-72, Black Pearls 700, Black Pearls 800, Vulcan XC-605, Regal 350, Regal 250, Black Pearls 570, and Vulcan XC-68.

In some embodiments, the carbon black is Vulcan XC-72.

In some embodiments, the substrate is present at a concentration of 5% to 50%, by total weight of the composition.

In some embodiments, the composition is a catalyst.

In some embodiments, the composition is for use in electrochemical ammonia synthesis.

According to an aspect of some embodiments of the present invention there is provided an electrochemical cell comprising the catalyst of the present invention, wherein the catalyst is a cathode.

In some embodiments, the electrochemical cell further comprises an electrolysis cell container comprising an inlet and an outlet; a distributor, wherein the distributor is in fluid communication with the cathode and the inlet; and an anode, wherein: (i) the anode and cathode are spaced apart from each other inside the container; (ii) the anode is in electrical communication with the cathode; (iii) the largest dimension of the anode and the cathode is defined by transverse cross-section dimensions of the electrolysis cell container; and (iv) the cathode is at least 50 fold thicker than the anode.

In some embodiments, the container is configured to allow a nitrogen gas to enter through the inlet and to contact the distributor.

In some embodiments, the distributor is configured to uniformly distribute the gas over a surface of the cathode.

In some embodiments, the cathode, the anode or both, is at least partially porous.

In some embodiments, the container is configured to allow a nitrogen gas to enter thereto and to contact the cathode.

In some embodiments, the electrochemical cell is configured to electrically connect an electric potential to the anode and to the cathode.

In some embodiments, the electrochemical cell is configured to synthesize ammonia at a rate of 1×10⁻¹¹ mol s⁻¹cm⁻² to 1×10⁻⁷ mol s⁻¹cm⁻² at 1 atm N₂.

In some embodiments, the electrochemical cell is configured to synthesize ammonia at a rate of at least 1×10⁻⁹ mol cm⁻² s⁻¹ on the catalyst at 1 atm N₂.

In some embodiments, the electrochemical cell is further configured to synthesize hydrogen.

In some embodiments, the anode is dimensioned to curb production of hydrogen.

In some embodiments, the remaining gas is directed via the outlet into a collecting chamber.

In some embodiments, the collecting chamber is an acid trap.

In some embodiments, the anode comprises comprise nickel, iron, zinc, cobalt, chromium, titanium, or any oxide or a combination thereof.

In some embodiments, the container further comprises an alkaline electrolyte solution.

In some embodiments, the electrolyte solution is saturated with nitrogen.

In some embodiments, the alkaline electrolyte solution is a sodium hydroxide (NaOH) solution, potassium hydroxide (KOH) solution or lithium hydroxide (LiOH) solution.

In some embodiments, the alkali electrolyte solution is present at a concentration of 0.1 to 5 M.

According to an aspect of some embodiments of the present invention there is provided a process of synthesizing ammonia, the process comprising: (i) contacting a nitrogen gas with the cathode of the electrochemical cell of the present invention, and (ii) applying an electric potential to the anode and the cathode, thereby obtaining the ammonia.

In some embodiments, the synthesis is performed at a temperature of from 20° C. to 80° C.

In some embodiments, the temperature is in the range of from 20° C. to 60° C.

In some embodiments, the synthesis is characterized by a faradaic efficiency in the range of 1% to 30%.

In some embodiments, the rate of ammonia production is in the range of 1×10⁻¹¹ mol s⁻¹cm⁻² to 1×10⁻⁷ mol s⁻¹cm⁻².

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A-1D present graphs showing linear sweep voltammograms (LSVs) of Vulcan XC-72 (FIG. 1A), Pt/C (FIG. 1B), Ru/C (FIG. 1C) and RuPt/C modified electrodes (FIG. 1D) in argon saturated (curve “1”) and nitrogen saturated (curve “2”) 1.0M KOH solution. Scan rate: 1 5 mV/s;

FIGS. 2A-2C present non-limiting schematic illustrations of electrochemical cell used for nitrogen reduction reaction (FIGS. 2A and B), and a photographic image showing the formation of ammonia in both electrolyte (1.0 M KOH) and acid trap (1 mM H₂SO₄) (FIG. 2C);

FIGS. 3A-3E present graphs showing chronoamperograms of RuPt/C modified electrodes in 1.0M KOH under nitrogen atmosphere at various applied potentials (FIG. 3A); the calibration curve of MMO (1.0M KOH) electrode with respect to reversible hydrogen electrode (RHE). (E (RHE)=E (MMO)+0.825V); MMO: mercury mercuric oxide (FIG. 3B); correlation between rate of ammonia formation and Faradaic efficiency at different potentials (FIG. 3C); chronoamperometry of RuPt/C modified electrodes in 1.0M KOH under nitrogen atmosphere at different temperatures (FIG. 3D); and the rate of ammonia formation and Faradaic efficiency at various temperatures (FIG. 3E);

FIGS. 4A-B presents mass spectrum of gas stream produced at RuPt/C catalyst in 1.0 M KOH at 50° C. under open circuit potential;

FIGS. 5A-5D present mass spectrograms of hydrazine (Figure SA); ammonia (FIG. 5B) hydrogen (FIG. 5C) and chronoamperograms of RuPt/C modified electrode (FIG. 5D) in 1.0M KOH under nitrogen atmosphere at various applied potentials;

FIG. 6 presents a graph showing the current density of profile of RuPt/C at an applied potential of 0.023V vs. RHE;

FIGS. 7A-D present XRD patterns of Fe₂O₃ (FIG. 7A) and Fe₂O₃/TiO₂ composite (FIG. 7B); SEM images of Fe₂O₃/TiO₂ (FIG. 7C), and EDX images of the composite material (FIG. 7D);

FIGS. 8A-B present optimization of molar rations of Fe(NO₃)₃ and TiO₂ (FIG. 8A) and EDX spectrum of α-Fe₂O₃/TiO₂/C composite;

FIGS. 9A-D present LSVs of nickel foam (FIG. 9A); TiO₂/C (FIG. 9B); Fe₂O₃ (FIG. 9C) and Fe₂O₃/TiO₂ (FIG. 9D) coated nickel-foam electrodes in argon-saturated and nitrogen-saturated 1.0 M KOH solution; scan rate: 5 mV/s;

FIGS. 10A-B present XRDs of Hematite/TiO₂ catalysts before (FIG. 10A) and after (FIG. 10B) applied potential (−0.277 V vs. RHE);

FIGS. 11A-C present chronoamperograms of Fe₂O₃/TiO₂/C coated nickel-foam electrodes in 1.0 M KOH under nitrogen atmosphere at various applied potentials (FIGS. 11A, B), and correlation between rate of ammonia formation and faradaic efficiency at different potentials (FIG. 11C);

FIGS. 12A-C present chronoamperograms of Fe₂O₃/TiO₂/C coated nickel-foam electrodes in 1.0 M KOH under nitrogen atmosphere at various temperatures (FIG. 12A), correlation between rate of ammonia formation and faradaic efficiency at various temperatures (FIG. 12B), and calculated activation energy of Fe₂O₃/TiO₂/C catalyst for NRR (FIG. 12C);

FIGS. 13A-B present chronoamperograms of Fe₂O₃/TiO₂/C coated nickel-foam electrodes in nitrogen-saturated and air-saturated 1.0 M KOH solution (FIG. 13A), and stability test of Fe₂O₃/TiO₂/C coated nickel-foam electrodes (five consecutive NRR measurements) at an applied potential of −0.377 V (FIG. 13B);

FIGS. 14A-D present mass spectra of an ammonia generator and outcoming gas stream at a Fe₂O₃/TiO₂/C catalyst in 1.0 M KOH at room temperature under open-circuit potential (FIG. 14A) and an applied potential of −0.477 V (FIG. 14B), mass spectrograms of hydrogen (FIG. 14C) and ammonia (FIG. 14D) at different potentials;

FIG. 15 presents electrochemical oxidation of ammonia on nickel foil electrode; conditions: scan rate 5 mV s⁻¹, standard TP, 1.0 M KOH, Ni foil working, MMO (1.0 M KOH) reference and Ni counter electrode;

FIGS. 16A-C present Calibration curves of the indophenol method (FIG. 16A), UV-Vis spectra recorded at 2λ=655 nm for different concentrations of ammonia (FIG. 16B), and calibration curves of Nessler's method (FIG. 16C);

FIG. 17 presents STEM image of RuSn nanoparticles attached to the carbon support;

FIGS. 18A-B present LSV of RuSn/C and Ru/C (dashed line) recorded in a nitrogen saturated 0.1M Na₂SO₄ at a scan rate of 5 mV s⁻¹ (FIG. 18A) and ammonia formation rate and Faradaic efficiency expressed as a function of an applied potential (FIG. 18B);

FIGS. 19A-B present LSV of RuSn/C and Ru/C (dashed line) recorded in a nitrogen saturated 0.1M Na₂SO₄ at a scan rate of 5 mV s−1, electrode area of 2 cm² (FIG. 19A), and ammonia formation rate and Faradaic efficiency expressed as a function of an applied potential (FIG. 19B);

FIGS. 20A-B present the elements of Fuel Cell (FIG. 20A): two carbon plates with channels for gases (1), cathode (2), anode (3), membrane (4) and Gasket (5); and a schematic representation of working condition of fuel cell (FIG. 20B);

FIGS. 21A-B present a linear sweep voltammograms of nickel foil anode-alkaline membrane-Fe₂O₃/TiO₂ composite-cathode cell configuration under nitrogen gas atmosphere (FIG. 21A) and nitrogen gas flow rate: 20 ml/min (FIG. 21B); chronoamperograms of above cell configuration at 0.4 V;

FIG. 22 presents image of Bottle cell: 1—working electrode (cathode); 2—vessel; 3—N2 introducing; 4—anode tube with electrode; 5—rubber cork;

FIG. 23 presents schematic represnataion of two electrode Electrochemical cell without membrane (Prototype 3);

FIG. 24 presents ammonia formation rate over time at RT and 50° C. using Prototype 3;

FIG. 25 presents the Effect of KOH concentration on the rate of electrochemical ammonia formation (Prototype 3); and

FIG. 26 presents the stability of Fe₂TiO₃/TiO₂/C electrode.

### DETAILED DESCRIPTION OF THE INVENTION

The present invention, in some embodiments thereof, relates to catalysts comprising a first metal component and a second metal component, and uses thereof for nitrogen reduction, e.g., for the electrochemical synthesis of ammonia at ambient temperature and pressure, by using water and pure nitrogen gas or air.

According to some embodiments, the present invention relates to a composition comprising one or more metal elements. In some embodiments, the present invention relates to a composition comprising a bimetallic catalyst. In some embodiments, the composition comprises two or more catalytically active components. In some embodiments, the catalytically active components induce a synergistic effect on each other.

In some embodiments, the composition has high electrocatalytic activity towards nitrogen reduction. In some embodiments, the electrocatalytic nitrogen reduction is carried out at ambient pressure and temperature in aqueous media by using either air or pure nitrogen as nitrogen sources.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

### The Composition

According to some embodiments, the present invention provides a composition comprising a first metal component comprising one or more metals and a second metal component comprising one or more metals, wherein at least one surface of the second metal component is coated with the first metal component; the molar ratio of the first metal component to the second metal component are in the range of 1:9 to 9:1, and the composition is in the form of particles.

In some embodiments, the composition comprises a first metal component comprising one or more metals alloying with a second metal component comprising one or more metals.

In some embodiments, the molar ratio of the first metal component to the second metal component are in the range of 1:9 to 9:1, 2:9 to 9:1, 3:9 to 9:1, 4:9 to 9:1, 5:9 to 9:1, 6:9 to 9:1, 7:9 to 9:1, 8:9 to 9:1, 9:9 to 9:1, 1:9 to 9:2, 1:9 to 9:3, 1:9 to 9:4, 1:9 to 9:5, 1:9 to 9:6, 1:9 to 9:7, 1:9 to 9:8, or 1:9 to 9:9, including any range therebetween.

In some embodiments, the particles have a size in the range of 1 nm to 50 μm, 3 nm to 50 μm, 5 nm to 50 μm, 10 nm to 50 μm, 25 nm to 50 μm, 50 nm to 50 μm, 100 nm to 50 μm, 250 nm to 50 μm, 500 nm to 50 μm, 1 nm to 900 nm, 1 nm to 800 nm, 1 nm to 500 nm, 1 nm to 250 nm, or 1 nm to 100 nm, including any range therebetween.

In some embodiments, the first metal component and/or second metal component comprise two metals.

In some embodiments, the first metal component comprises Fe, Ru, Pt, Pd, Sn, Co, Mo, and any combination thereof.

In some embodiments, the second metal component comprises Ti, Sn, Ru, Fe, Pt, Pb, Bi, Hg, Cd, and any combination thereof.

In some embodiments, the first metal component comprises the active metal. In some embodiments, the second metal component comprises a co-catalyst.

Non-limiting examples of co-catalysts according to the present invention include Sn, Pb, Bi, Hg, Cd, Ti and their corresponding oxides, sulfides, selenides, nitrides, and phosphides.

In some embodiments, a composition as described herein is for use in electrochemical ammonia synthesis.

In some embodiments, the second metal component improves the activity of the first metal component. In some embodiments, a composition comprising a second metal component (also referred to as “co-catalyst”), has a higher ammonia production, when compared to the corresponding composition without the second metal component.

In some embodiments, ammonia production using a composition according to the present invention comprising a second metal component is at least 1 fold, at least 2 fold, at least 5 fold, at least 10 fold, at least 12 fold, at least 50 fold, or at least 100 fold, higher then when using the corresponding composition without the second metal component. In some embodiments, second metal component is not consumed in the process.

In some embodiments, the second metal component prevents hydrogen evolution during electrochemical ammonia synthesis. In some embodiments, the second metal component prevents the formation of hydrogen next to the first metal component.

In some embodiments of the present invention, there is provided a composition comprising Fe₂O₃, Fe₃O₄ or Fe₂O₃FeO and TiO₂. In some embodiments, the composition comprises Fe₂O₃, Fe₃O₄ or Fe₂O₃FeO as the first metal component and TiO₂ as the second metal component, in a molar ratio in the range of 1:9 to 9:1.

In some embodiments, the first metal component is Fe and the second metal component is Sn, in a molar ratio in the range of 1:9 to 9:1.

In some embodiments, the first metal component is Ru or Fe and the second metal component is Pt or Pd or Sn, in a molar ratio in the range of 1:9 to 9:1.

In some embodiments, the first metal component is Pt and the second metal component is Ru in a molar ratio in the range of 1:9 to 9:1.

The present invention, in some embodiments thereof, relates to palladium-tin based catalysts.

In some embodiments of the present invention, there is provided a composition comprising Ruthenium (Ru) and Platinum (Pt), wherein the molar ratio of the Ru to the Pt is in the range of 1:10 to 10:1, respectively.

In some embodiments, the Ru:Pt molar ratio is in the range of 1:10 to 9:1, respectively. In some embodiments, the Ru:Pt molar ratio is in the range of 1:9 to 9:1, respectively. In some embodiments, the Ru:Pt molar ratio is in the range of 1:8 to 8:1, respectively. In some embodiments, the Ru:Pt molar ratio is in the range of 1:7 to 7:1, respectively. In some embodiments, the Ru:Pt molar ratio is in the range of 1:6 to 6:1, respectively. In some embodiments, the Ru:Pt molar ratio is in the range of 1:5 to 5:1, respectively. In some embodiments, the Ru:Pt molar ratio is in the range of 1:4 to 4:1, respectively. In some embodiments, the Ru:Pt molar ratio is in the range of 1:3 to 3:1, respectively. In some embodiments, the Ru:Pt molar ratio is in the range of 1:2 to 2:1, respectively. In some embodiments, the Ru:Pt molar ratio is 1:1, respectively.

In some embodiments, the Ru:Pt molar ratio is 10:1, 9:1, 8:1, 7:1, 6:1, 5:1, 4:1, 3:1, 2:1, 1:1, 1:2, 1:3, 1:4, 1:5, 1:6, 1:7, 1:8, 1:9, or 1:10, respectively, including any value and range therebetween.

In exemplary embodiments, the molar ratio of the Ru to the Pt is about 1:1 (±20%).

In some embodiments, the composition is in the form of a core-shell structure in which the core particle comprises metal particles covered with the outer layer comprising a metal or an alloy thereof. In some embodiments, the composition is in the form of a core-shell structure in which the core particle comprises a first metal component particles covered with the outer layer comprising a second metal component as described herein or an alloy thereof.

In some embodiments, the composition is in the form of a core-shell structure in which the core particle comprises metal particles covered with the outer layer comprising a metal or an alloy thereof.

In some embodiments, the term “shell”, refers to the coating domain surrounding the core.

By “coated by a shell” it is meant to refer to a composition of two or more entities, namely an entity that defines an enclosure (the enclosing entity, i.e. the shell) and the entity (or entities) that is being at least partially enclosed therein. In some embodiments, the coating may be conformal with the exact contour of the core. In some embodiments, the core comprises or is made of a plurality of particles.

Particle(s) coated by a shell may be characterized by a discrete inner and outer surface wherein the inner surface constitutes the boundary of the enclosed area or space. The enclosed area or space may be secluded from the exterior area of space which is bounded only by the outer surface.

In the context of the present invention, the closure of the enclosing entity may depend of the size, shape and chemical composition of the entity that is being enclosed therein, such that the enclosing entity may be “closed” for one entity and at the same time be “open” for another entity. For example, structures presented herein are closed with respect to certain chemical entities which cannot pass through their enclosing shell, while the same “closed” structures are not closed with respect to other entities.

As used herein, the term “alloy”, refers to a monophasic or polyphasic metallic material of a binary or polynary system. The starting components (alloy elements) may enter into metallurgical interactions with one another and thereby lead to the formation of new phases (e.g., mixed crystals, intermetallic compounds, superlattice).

In some embodiments, the alloy can include deposition of two or more target materials, so as to form a di-segmented nanostructure (e.g., if two or more target metals are deposited sequentially), a tri-segmented nanostructure (e.g., if three or more target metals are deposited sequentially), etc. At least one of the deposited metals may be etched at later stages of the process. The process can include deposition of one or more such materials.

Herein throughout, the expression “deposited on at least one surface” is also referred to herein, for simplicity, as a coating on substrate, or surface of a substrate.

In some embodiments, the term “coating”, or any grammatical derivative thereof, is defined as a coating that (i) is positioned above the substrate, (ii) is not necessarily in contact with the substrate, that is to say one or more intermediate coatings may be arranged between the substrate and the coating in question (however, it may be in contact with the substrate), and (iii) does not necessarily completely cover the substrate.

### Substrate

In some embodiments, the composition further comprises a substrate. In some embodiments, a first metal component and a second metal component are deposited on at least one surface of the substrate.

In some embodiments, the substrate comprises carbon.

In some embodiments, the substrate comprises a co-catalyst. In some embodiments, a co-catalyst is a substrate to the active material and helps hindering the competing hydrogen reduction reaction.

Substrate usable according to some embodiments of the present invention can have, for example, organic or inorganic surfaces.

In some embodiments, the substrate is selected from, but is not limited to, carbon, a metal oxide, a polymer, or any combination thereof.

Non-limiting exemplary substrates are selected from activated carbon, graphite, carbon nanotube, metal mesh or foam, Ni foam, Sn foam, or woven, ceramic materials, Toray paper, carbon cloth, carbon paper, or any combination thereof.

Non-limiting exemplary carbon is selected from carbon black, activated carbon, graphite, carbon nanotube, and any combination thereof.

The carbon black may be selected from, without being limited thereto, carbon nanotube, graphene, Vulcan XC-72, Black Pearls 700, Black Pearls 800, Vulcan XC-605, Regal 350, Regal 250, Black Pearls 570, and Vulcan XC-68, or any combination thereof.

In exemplary embodiments, the carbon comprises Vulcan XC-72.

In some embodiments, the composition described herein is identified for use as a catalyst or as an electro-catalyst. In some embodiments, the catalyst is a cathode.

In some embodiments, the substrate is present at a concentration of 2% to 50%, by total weight of the composition. In some embodiments, the substrate is present at a concentration of 2% to 30%, by total weight of the composition. In some embodiments, the substrate is present at a concentration of 3% to 25%, by total weight of the composition. In some embodiments, the substrate is present at a concentration of 4% to 20%, by total weight of the composition. In some embodiments, the substrate is present at a concentration of 5% to 15%, by total weight of the composition. In some embodiments, the substrate is present at a concentration of 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, or 30%, by total weight of the composition, including any value and range therebetween. In some embodiments, the substrate is present at a concentration of about 10%, by total weight of the composition.

### The Apparatus

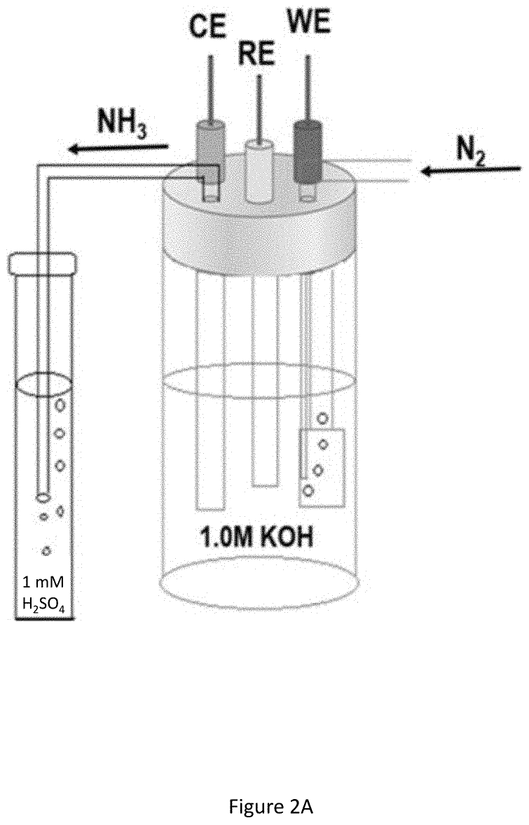

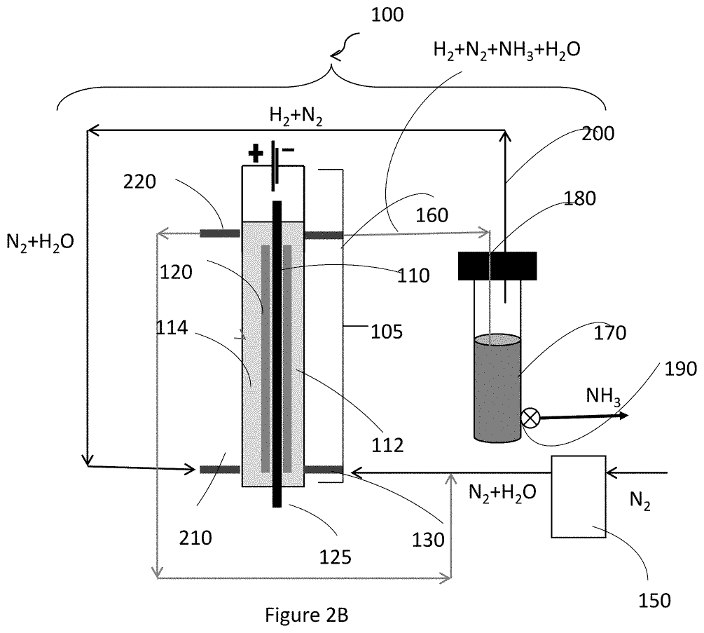

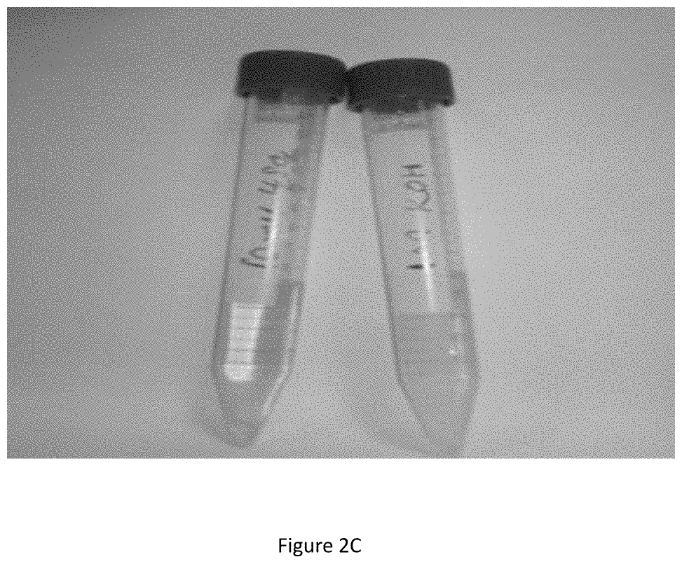

FIG. 2B presents a schematic illustration of an apparatus containing electrochemical cell used for nitrogen reduction reaction.

The apparatus 100 may be used for synthesizing ammonia by using an alkali electrolyte. The apparatus 100 may be used for synthesizing hydrogen. Apparatus 100 may have a chamber or a container 105 configured to contain the alkali electrolyte. Apparatus 100 may have a working electrode (e.g., a cathode) 110 and an anode 120. Working electrode 110 and anode 120 may be disposed separately from each other in chamber 105.

In some embodiments, ammonia may be synthesized at an interface of cathode 110.

Apparatus 100 may have an electrode separation membrane 125. Electrode separation membrane 125 may be disposed in chamber 105. Electrode separation membrane 125 may be disposed in chamber 105 between cathode 110 and anode 120 and may electrically separate cathode 110 and anode 120, e.g., by dividing chamber 105 to do define a cathode zone 112 and an anode zone 114. Non-limiting exemplary working electrodes 110 (e.g., cathode) are described herein throughout. Non-limiting exemplary anodes 120 comprise nickel (Ni), iron, zinc, cobalt, chromium, titanium, or any oxide or a combination thereof.

Chamber 105 may have a nitrogen inlet 130 (also referred to as “first nitrogen inlet”). Inlet 130 may be located at a lower part of the chamber 105 e.g., in cathode zone 112. Nitrogen inlet 130 may include a pipe of various shapes and sizes, connected to, attached to, or integrally formed with chamber 105. Nitrogen inlet 130 may allow gas (e.g., nitrogen) to enter chamber 105. Optionally, the gas (nitrogen) may be humidified with water vapor.

Apparatus 100 may be connected to a nitrogen supply unit 150 allowing to supply nitrogen via nitrogen inlet 130. Nitrogen gas may enter nitrogen supply unit 150, and, optionally, the nitrogen may be humidified in nitrogen supply unit 150.

Apparatus 100 may have an ammonia outlet 160. Ammonia outlet 160 may be located in chamber 105, e.g., in cathode zone 112. Ammonia outlet 160 may allow ammonia exit chamber 105. Ammonia outlet 160 may further allow hydrogen gas generated to exit chamber 105. Ammonia outlet 160 may further allow other gasses involved in the ammonia synthesis, e.g., nitrogen or water, to exit chamber 105.

Apparatus 100 may have an ammonia trap 170. Ammonia trap 170 may be in the form of a container configure to contain an acid (e.g., sulfonic acid). Ammonia trap 170 may have an inlet 180, allowing a gas (e.g., ammonia and other gasses) exiting ammonia outlet 160 to enter ammonia trap 170. Ammonia trap 170 may have a first outlet 190 allowing ammonia exit therefrom. First outlet 190 may be located at a lower part of ammonia trap 170. First outlet 190 may include a valve allowing to control the rate of ammonia flow exiting outlet 190. Ammonia trap 170 may have a second outlet 200 allowing gasses (e.g., nitrogen and hydrogen) to exit therefrom. Outlet 190 may be located at an upper part of ammonia trap 170.

Chamber 105 may have another nitrogen inlet 210 (also referred to as “second nitrogen inlet”). Inlet 210 may be located at a lower part of the chamber 105 e.g., in anode zone 114. Nitrogen inlet 210 may include a pipe of various shapes and sizes, connected to, attached to, or integrally formed with chamber 105. Nitrogen inlet 130 may further allow gasses (e.g., nitrogen) exiting second outlet 200 to reenter, or recirculate to, chamber 105.

Apparatus 100 may have a gas outlet 220. Gas outlet 220 may be located in chamber 105, e.g., in anode zone 114. Gas outlet 220 may allow gasses (e.g., gasses involved in the ammonia synthesis, such as nitrogen or water) exit chamber 105. Gas outlet 220 may include a pipe of various shapes and sizes, connected to, attached to, or integrally formed with chamber 105. Optionally, gasses exiting chamber 105 via gas outlet 220, may be allowed to reenter, or recirculate, to chamber 105 via nitrogen inlet 130.

In some embodiments apparatus 100 is configured to synthesize ammonia at a rate (in mol cm⁻² s⁻¹) of 1×10⁻⁸, at least 5×10⁻⁸, at least 1×10⁻⁹, 2×10⁻⁹, at least 3×10⁻⁹, 4×10⁻⁹, at least 5×10⁻⁹, including any value and range therebetween, e.g., at 1 atm N₂.

In some embodiments apparatus 100 is configured to synthesize ammonia at a rate (in mol cm⁻² s⁻¹) of 1×10⁻⁸, at least 5×10⁻⁸, at least 1×10⁻⁹, 2×10⁻⁹, at least 3×10⁻⁹, 4×10⁻⁹, at least 5×10⁻⁹, including any value and range therebetween, e.g., at 1 atm N₂.

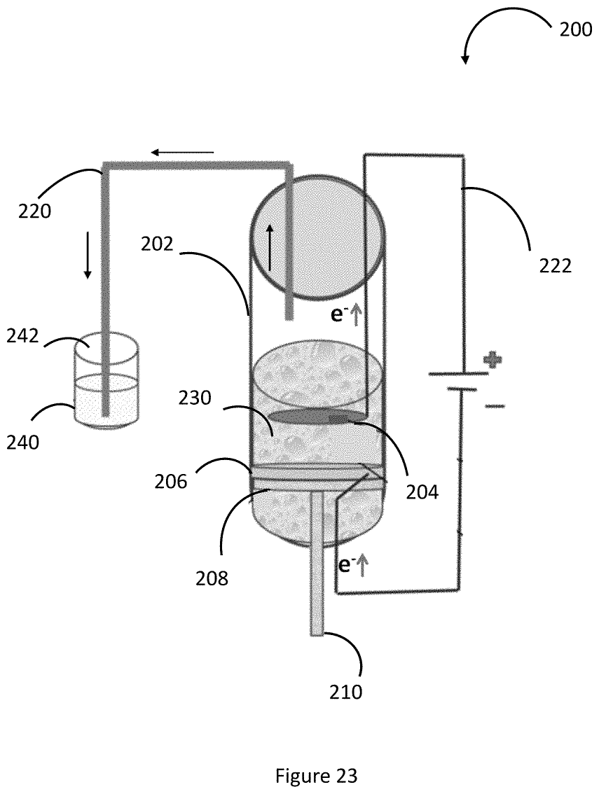

Reference is now made to FIG. 23, which is a plan view simplified illustration of an exemplary apparatus containing an electrochemical cell used for nitrogen reduction reaction, according to some embodiments of the present invention. In some embodiments, the apparatus 200 comprises an electrolysis cell container 202 comprising an inlet 210 and an outlet 220, a cathode 206, a distributor 208 in fluid communication with the cathode 206 and the inlet 210, and an anode 204.

In some embodiments, the anode 204 and cathode 206 are spaced apart from each other inside the container 202. In some embodiments, the anode 204 is in electrical communication 222 with the cathode 206.

In some embodiments, the greater the surface area of the cathode, and in some embodiments also the surface area of the anode the better the performance of the electrochemical cell. However, the surface area of the anode 204 and the cathode 206 is limited, and therefore determined, by wall/s of the electrochemical cell and hence the cross-section of the electrolysis cell container 202. The largest dimension of the anode 204 and the cathode 206 is therefore defined by transverse cross-section dimensions of the electrolysis cell container 202.

In some embodiments, the cathode 206 is at least 50 fold thicker than the anode 204. In some embodiments, the cathode 206 is at least 60 fold, at least 65 fold, at least 70 fold, at least 75 fold, at least 80 fold, at least 85 fold, at least 90 fold, at least 95 fold, at least 100 fold, at least 110 fold, at least 120 fold, or at least 150 fold, thicker than the anode 204.

In some embodiments, the container 202 of the electrochemical cell 200 is configured to allow a nitrogen gas to enter through the inlet 210 and to contact the distributor 208.

The inlet 210 is located across a container wall on the cathode side of the apparatus facing the distributor 208 e.g., in cathode 206 zone. The distributor 208 is disposed between inlet 210 and cathode 206. The inlet 210 may include a pipe of various shapes and sizes, connected to, attached to, or integrally formed with container 202. The inlet 210 allows gas (e.g., nitrogen) to enter the container 202, where it comes into contact (e.g., enters) with distributor 208 and is uniformly distributed over a surface of the cathode 206. In some embodiments, the cathode 206 is at least partially porous and gas exiting distributor 208 is uniformly distributed throughout cathode 206. Optionally, the gas (nitrogen) may be humidified with water vapor.

In some embodiments, the cathode 206 is at least partially porous. In some embodiments, the distributor 208, is configured to uniformly distribute incoming gas and/or gas containing solution. E.g., distributor 208 may be made of a porous material, comprise a sieve or have a structure similar to that of a showerhead, or the like and is positioned in contact with or in close proximity to the cathode 206, and pressing the same, in order to allow gas distribution within cathode 206. The distributor 208 is configured to uniformly distribute the gas or gas containing solution over the surface of the cathode 206.

In some embodiments, the anode 204 comprises an at least partially porous material, and is configured to allow for an electrolyte solution 230 to go through. In some embodiments, the anode 204 is dipped in the electrolyte solution 230.

Non-limiting exemplary anodes 204 comprise nickel (Ni), iron, zinc, cobalt, chromium, titanium, or any oxide or a combination thereof.

In some embodiments, in the process of nitrogen reduction reaction, there is a hydrogen evolution competing reaction. The anode 204 is dimensioned to curb production of hydrogen. In some embodiments, anode 204 is capable of oxidizing hydrogen. Anode 204, captures the formed hydrogen that can used, saving energy of the total process. In some embodiments, the anode 204 avoids the over-generation of hydrogen.

In some embodiments, the apparatus 200 has an outlet 220. In some embodiments, the outlet 220 supports flow of gas. In some embodiments, the outlet 220 is an outlet for the ammonia formed during a nitrogen reduction reaction process. In some embodiments, the outlet 220 may be located in the container 202, facing the anode 204. The outlet 220 is configured to provide a pathway for hydrogen gas generated in the process as well as other gasses involved in the ammonia synthesis, e.g., nitrogen or water, to exit container 202.

In some embodiments, the apparatus 200 comprises a collecting chamber 240. In some embodiments, the collecting chamber 240, comprises an acid trap. Collecting chamber 240 may be in the form of a container configured to contain an acid (e.g., sulfonic acid). Collecting chamber 240 comprises an inlet 242, through which gas (e.g., ammonia and other gasses) exiting via outlet 220 enters collecting chamber 240.

In some embodiments, the apparatus 200 can work with minimal quantity of electrolyte 230. Since ammonia dissolves in aqueous solution, the electrochemically generated ammonia saturates quickly in electrolyte 230 and comes out from the cell through outlet 220 and is collected in the collecting chamber 240.

In some embodiments, apparatus 200, is configured to synthesize ammonia at a rate (in mol cm⁻² s⁻¹) of 1×10⁻⁸ to 5×10⁻⁹.

In some embodiments, apparatus 200, is configured to synthesize ammonia at a rate (in mol cm⁻² s⁻¹) of 1×10⁻⁸ to 5×10⁻⁹.

Apparatus 100 and apparatus 200 may have various components of the apparatus disclosed herein, such as any of the valves, sensors, weirs, blowers, fans, dampers, or pumps, etc.

Operation of the gas rate in the inlet, outlet and the pipes, and the recirculation rates may be controlled by a control unit assisted by the valves, sensors, weirs, blowers, fans, dampers, or pumps, etc.

The dimensions of each component of the apparatus are selected to be sufficient, for a given desired fluidization and to provide sufficient contact time to provide e.g., a desired level of water/nitrogen consumption and/or ammonia regeneration.

Conditions may be monitored using any suitable type monitoring devices e.g., a computer-implemented system. Variables that may be tracked include, without limitation, pH, temperature, electric potential, conductivity, turbidity, rate of the gas flow in each inlet or outlet, concentration of the alkali solution. These variables may be recorded throughout apparatus 100 and apparatus 200.

A monitoring device, a control unit, or a controller (e.g., computer) may also be used to monitor, control and/or automate the operation of the various components of the systems disclosed herein, such as any of the valves, sensors, weirs, blowers, fans, dampers, pumps, etc.

The present invention may be a system, a method, and/or a computer program product. The computer program product may comprise a computer-readable storage medium. The computer-readable storage medium may have program code embodied therewith. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer disk, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

### The Electrochemical Cell

According to an aspect of some embodiments of the present invention there is provided an electrolysis cell having an electrocatalyst comprising the disclosed composition in an embodiment thereof. In some embodiments, the electrocatalyst is the cathode.

In some embodiments, the term “electrocatalyst” refers a specific form of a catalyst that functions at electrode surfaces or, in some embodiments, may be the electrode surface itself.

The term “electrochemical cell” or “cell” as used herein refers generally to a device that converts chemical energy into electrical energy, or electrical energy into chemical energy. Generally, electrochemical cells have two or more electrodes and an electrolyte, wherein electrode reactions occurring at the electrode surfaces result in charge transfer processes. Examples of electrochemical cells include, but are not limited to, batteries and electrolysis systems.

In some embodiments, the electrochemical cell is configured to synthesize ammonia at a rate of 1×10⁻¹¹ mol s⁻¹cm⁻² to 1×10⁻⁷ mol s⁻¹cm⁻² at 1 atm N₂.

In some embodiments, the electrochemical cell is configured to synthesize ammonia at a rate of 1×10⁻¹¹ mol s⁻¹cm⁻² to 1×10⁻⁷ mol s⁻¹cm⁻², 5×10⁻¹¹ mol s⁻¹cm⁻² to 1×10⁻⁷ mol s⁻¹cm⁻², 10×10⁻¹¹ mol s⁻¹cm⁻² to 1×10⁻⁷ mol s⁻¹cm⁻², 1×10⁻¹⁰ mol s⁻¹cm⁻² to 1×10⁻⁷ mol s⁻¹cm⁻², 10×10⁻¹⁰ mol s⁻¹cm⁻² to 1×10⁻⁷ mol s⁻¹cm⁻², 1×10⁻¹¹ mol s⁻¹cm⁻² to 1×10⁻⁸ mol s⁻¹cm⁻², or 1×10⁻¹⁰ mol s⁻¹cm⁻² to 1×10⁻⁸ mol s⁻¹cm⁻², including any range therebetween.

In some embodiments, the electrochemical cell is configured to synthesize hydrogen.

The present inventors have now surprisingly uncovered that the disclosed electrocatalyst enhances nitrogen reduction reaction.

In some embodiments, the nitrogen reduction reaction is performed in an alkaline electrolyte solution. In some embodiments, the solution refers to an aqueous solution.

In some embodiments, the solution refers to a non-alkaline solution.

Non-limiting examples of non-alkaline solutions according to the present invention include Na₂SO₄, NaCl, KCl, KBr, KnO₃, NaNO₃, NaClO₄ KClO₄, and KH₂PO₄.

The alkali aqueous solution refers that the aqueous solution is basic, and, as used herein, the alkali aqueous solution denotes a hydroxide of an alkali metal or an alkali earth metal element.

In some embodiments, the alkaline electrolyte solution is in the pH value of at least pH 11. In some embodiments, the alkaline electrolyte solution is in the pH value of at least pH 12. In some embodiments, the alkaline electrolyte solution is in the pH value of at least pH 13. In some embodiments, the alkaline electrolyte solution comprises a sodium hydroxide (NaOH) solution. In some embodiments, the alkaline electrolyte solution comprises a potassium hydroxide (KOH) solution. In some embodiments, the alkaline electrolyte solution comprises a lithium hydroxide (LiOH) solution. In some embodiments, the alkaline electrolyte concentration is in the range of 0.001M to 5M. In some embodiments, the alkaline electrolyte concentration is in the range of 0.01M to 3M. In some embodiments, the alkaline electrolyte concentration is in the range of 0.05M to 1M. In some embodiments, the alkaline electrolyte concentration is in the range of 0.05M to 0.5M.

In some embodiments, the alkaline electrolyte concentration is in the range of 0.5M to 3.5M. In some embodiments, the alkaline electrolyte concentration is approximately 3M.

### Ammonia Synthesis

In some embodiments, ammonia may be synthesized by using the electrolytic cell disclosed herein.

In some embodiments, there is provided a process of synthesizing ammonia, the process comprising: (i) contacting a humidified nitrogen gas with the cathode of the electrochemical cell disclosed herein in any embodiment thereof, and (ii) applying an electric potential to the anode and the cathode, thereby obtaining the ammonia.

The ammonia is synthesized by using an alkali solution as described above, according to an embodiment.

In some embodiments, the ammonia is synthesized by using an aqueous solution.

In some embodiments, the solution refers to a non-alkaline solution.

Non-limiting examples of non-alkaline solutions according to the present invention include Na₂SO₄, NaCl, KCl, KBr, KnO₃, NaNO₃, NaClO₄ KClO₄, and KH₂PO₄.

In some embodiments, the synthesis of the ammonia is performed at a temperature of from 10° C. to 80° C., 20 to 80° C., 10° C. to 70° C., 20° C. to 70° C., 30° C. to 80° C., 30° C. to 70° C. 30° C. to 65° C., or 30° C. to 60° C., including any range therebetween.

In some embodiments, the synthesis of the ammonia is performed at a temperature of from 25 to 30° C. In some embodiments, the synthesis of the ammonia is performed at a temperature of from 30 to 50° C.

In some embodiments, the synthesis of the ammonia is performed at a pressure of 500 to 2000 mm Hg. In some embodiments, the synthesis is performed at a pressure of 500 to 1000 mm Hg.

In some embodiments, the synthesis of the ammonia is performed at an ambient temperature. In some embodiments, the synthesis of the ammonia is performed at an ambient pressure. In some embodiments, the synthesis of the ammonia is performed at an ambient pressure and at an ambient temperature.

In some embodiments, the term “ambient pressure” is intended to mean approximately 740 mm Hg to about 780 mm Hg.

In some embodiments, the electric potential used in the synthesis of the ammonia is in the range of −0.4 V to 0.2 V, −0.3 V to 0.2 V, −0.3 V to 0.2 V, −0.3 V to 0.2 V, −0.1 V to 0.2 V, 0 V to 0.2 V, −0.4 V to 0.1 V, −0.4 V to −0.1 V, or −0.4 V to −0.2 V, including any range therebetween.

In some embodiments, the synthesis of the ammonia is performed at low electric potential. In some embodiments, the low electric potential avoid hydrogen evolution competing reactions.

In some embodiments, the rate of ammonia production can be increased by increasing the electric potential.

In some embodiments, the synthesis of ammonia is characterized by a faradaic efficiency in the range of 1% to 30%, 1% to 25%, 1% to 20%, 1% to 15%, 1% to 10%, 3% to 30%, 5% to 30%, 5% to 25%, 5% to 20%, 5% to 15%, or 5% to 10%, including any range therebetween.

In some embodiments, the synthesis of the ammonia is characterized by a faradaic efficiency of at least 1% wherein the electric potential is 0.023 V. In some embodiments, the synthesis of the ammonia is characterized by a faradaic efficiency of at least 3%, 5%, 8%, 10%, 12%, 15%, 18%, 20%, or 25%, wherein the electric potential is 0.023 V.

In some embodiments, the synthesis of the ammonia is characterized by a faradaic efficiency of at least 1% wherein the electric potential is 0.123 V. In some embodiments, the synthesis of the ammonia is characterized by a faradaic efficiency of at least 2% wherein the electric potential is 0.123 V. In some embodiments, the synthesis of the ammonia is characterized by a faradaic efficiency of at least 3% wherein the electric potential is 0.123 V. In some embodiments, the synthesis of the ammonia is characterized by a faradaic efficiency of at least 4% wherein the electric potential is 0.123 V. In some embodiments, the synthesis of the ammonia is characterized by a faradaic efficiency of at least 5% wherein the electric potential is 0.123 V.

In some embodiments, the synthesis of the ammonia is characterized by a rate of ammonia production is in the range of 1×10⁻¹¹ mol s⁻¹cm⁻² to 1×10⁻⁷ mol s⁻¹cm⁻², 5×10⁻¹¹ mol s⁻¹cm⁻² to 1×10⁻⁷ mol s⁻¹cm⁻², 10×10⁻¹¹ mol s⁻¹cm⁻² to 1×10⁻⁷ mol s⁻¹cm⁻², 1×10⁻¹⁰ mol s⁻¹cm⁻² to 1×10⁻⁷ mol s⁻¹cm⁻², 10×10⁻¹⁰ mol s⁻¹cm⁻² to 1×10⁻⁷ mol s⁻¹cm⁻², 1×10⁻¹¹ mol s⁻¹cm⁻² to 1×10⁻⁸ mol s⁻¹cm⁻², or 1×10⁻¹⁰ mol s⁻¹cm⁻² to 1×10⁻⁸ mol s⁻¹cm⁻², including any range therebetween.

General

The terms “comprises”, “comprising”, “includes”, “including”, “having” and their conjugates mean “including but not limited to”. The term “consisting of means “including and limited to”. The term “consisting essentially of” means that the composition, method or structure may include additional ingredients, steps and/or parts, but only if the additional ingredients, steps and/or parts do not materially alter the basic and novel characteristics of the claimed composition, method or structure.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, and electrochemical arts.

In those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

### EXAMPLES

Reference is now made to the following examples, which together with the above descriptions illustrate some embodiments of the invention in a non-limiting fashion.

### Example 1

### Materials and Methods

Ruthenium platinum black, normally Pt 50%, Ru 50% (atomic wt %), HiSPEC 6000 was purchased from Alfa Aesar. Vulcan XC-72 was procured from Cabot. Potassium hydroxide, isopropyl alcohol, PTFE (60 wt %) solution and nickel foil were procured from Aldrich. Anionic ionmer was purchased from Hephas Energy Co. Ltd. Toray carbon was purchased from fuel cell store.comtm.

RuPt/C slurry was prepared by adding RuPt and Vulcan XC 72 (9:1) into glass vial, to this mixture milli-Q water, isopropyl alcohol (1:1), PTFE solution (5 wt %) and inomer (2 wt %) were added and ultra-sonicated for 15 min. The prepared slurry was brush coated on Toray carbon electrode (1 cm⁻²) and dried at 80° C. under vacuum overnight.

The Biologic VSP workstation was used to carry out all electrochemical experiments. Hiden analytic HPR 20 mass spectrometry was used for qualitative analysis of gasses. The electrochemical experiments were performed using three electrode system consisting of RuPt/C as working, nickel foil as counter and mercury mercuric oxide (MMO) reference electrodes. 1.0 M KOH solution was used as electrolyte. The dissolved oxygen in electrode was removed by purging argon gas (99.999% pure) for 15 min. For electrochemical synthesis of ammonia, nitrogen gas (99.999% pure) was purged prior to the experiment. The electrochemically produced ammonia gas was trapped in 1 mM H₂SO₄ solution and rate of ammonia formation was calculated using the following equation 1:

$${r}_{NH 3} = \frac{[ {NH}_{4}^{+} ] \times V}{t \times A} \qquad [ 1 ]$$

where, [NH₄⁺] is the measured ammonium ion concentration, V is the volume of solution for ammonia collection, t is the time of electrochemical reaction and A is the area of the working electrode.

### Example 2

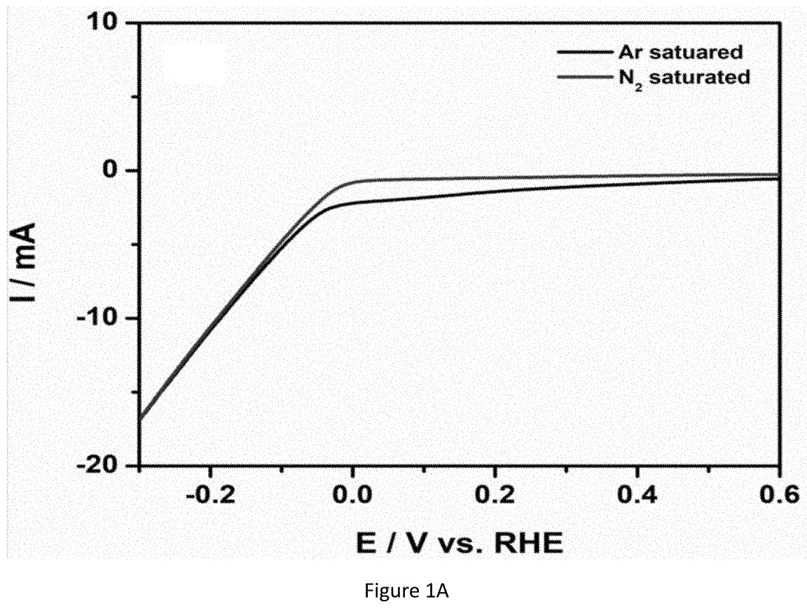

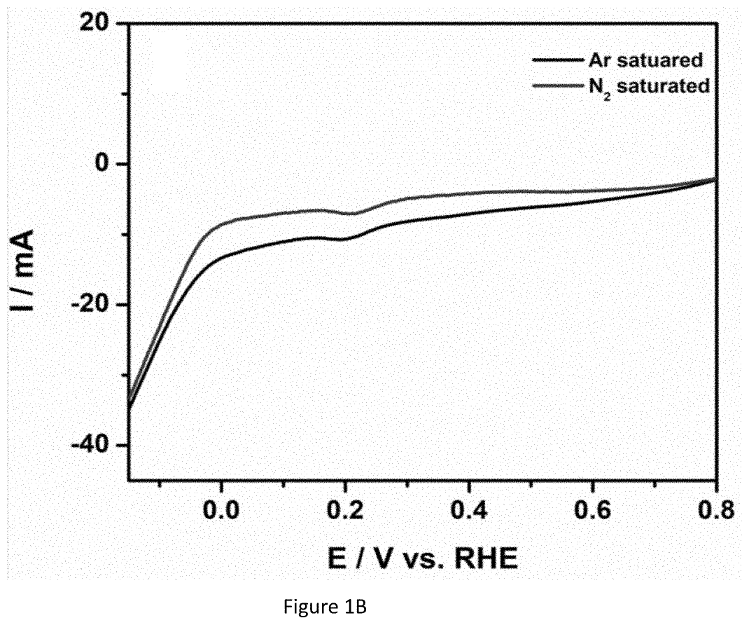

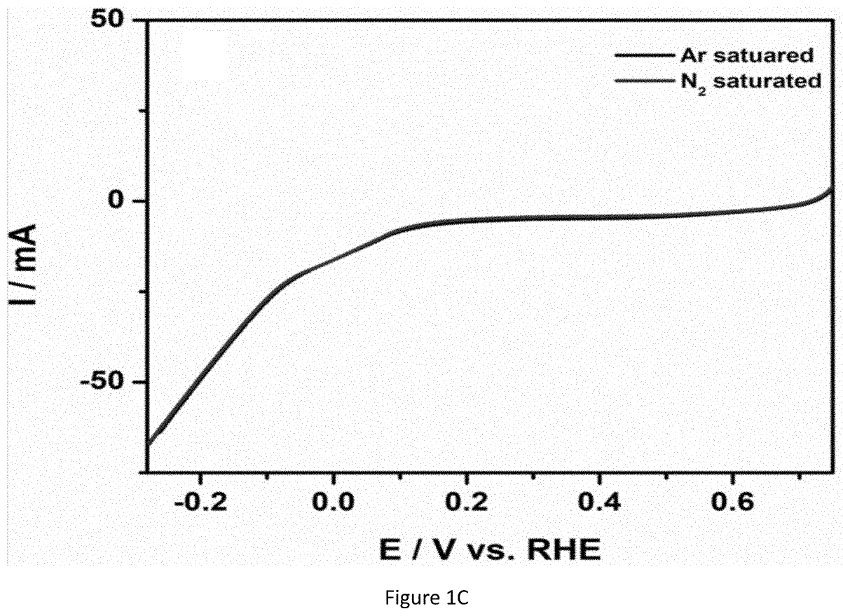

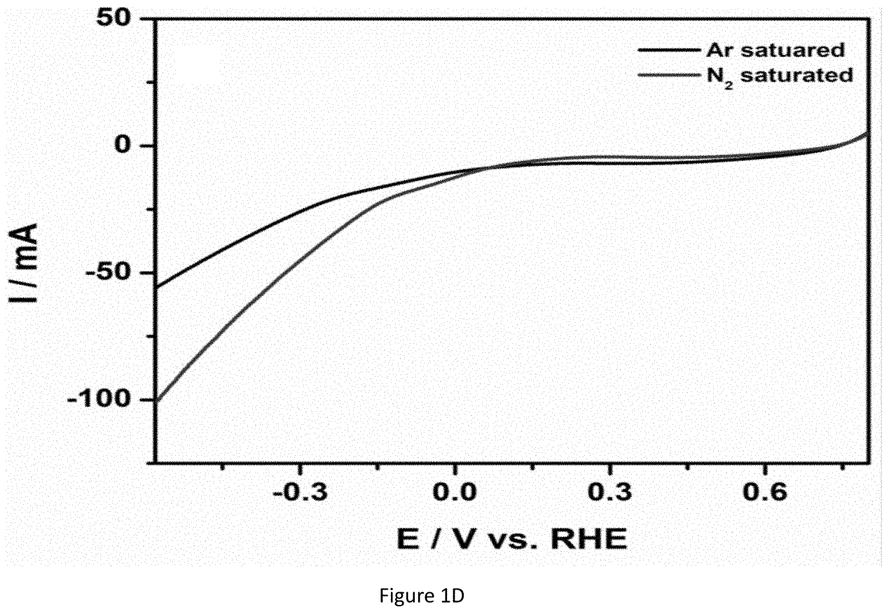

FIG. 1A shows linear sweep voltammograms (LSVs) of Vulcan XC 72 modified working electrodes in argon and nitrogen saturated solution. As expected, Vulcan XC-72 carbon did not show any catalytic activity for nitrogen reduction reaction (NRR).

In the present work, Pt/C modified electrode did not illustrate any catalytic activity towards aforementioned reaction (FIG. 1B). However, reduction peak ca. 0.2 V was noticed, which could be due to desorption of under potential deposited hydrogen.

Similarly, FIG. 1C exhibits LSVs of ruthenium/carbon (Ru/C) towards NRR. From this graph it can be observed that there is no significant change in the onset potential of the reaction under argon and nitrogen saturated solutions. Nevertheless, RuPt/C catalyzed electrode exhibited lower onset potential (ca.0.05V) than platinum carbon (Pt/C, ca.0.025V) and ruthenium carbon (Ru/C, ca.0.1V) electrodes in nitrogen saturated solution which is obviously due to NRR (see FIG. 1D). The observed onset potential of NRR is more positive (i.e. −0.077V vs RHE). At a more negative cell potential, the rate of ammonia formation decreased significantly due to hydrogen reduction reaction and became more dominant than that of NRR.

Without being bound by any particular mechanism, it is assumed that the lower onset potentials and higher NRR currents are attributed to bifunctional mechanism, where the N₂ is adsorbed on Ru site while the Pt—H provide the hydrogen in the PtRu catalysts. According to reaction (1):

Ru≡N_{ad}+3Pt—H_{ad}→PtRu+NH₃ (1)

Alternatively, the bifunctionalty of PtRu can also be ascribed to removal of hydrogen from Ru sites through reaction 2:

Ru-H_{ad}+Pt-H_{ad}→H₂ RuPt (2)

The Effect Potential and Temperature

As mentioned above, electrochemical ammonia synthesis was carried out in electrochemical cell consisting of RuPt/C working electrode, nickel foil as counter electrode and MMO (1.0M KOH) as reference electrode in 1.0M KOH solution.

During the course of the reaction, known volume of nitrogen gas was continuously fed into vicinity of cathode as shown in FIGS. 2A-C along with plausible reaction for ammonia formation. At applied potential nitrogen gas got reduced into ammonia gas at the cathode electrode.

In exemplary procedures, the produced gases were bubbled in 1 mM H₂SO₄ trap. The minimum threshold potential is required below which electrochemically it is not possible to produce ammonia:

Cathode: 2N₂+12H₂O+12e⁻→4 NH₃+12 OH⁻ (1)

Anode: 12 OH⁻→3O₂+6H₂O+12e⁻ (2)

Overall: 2N₂+6H₂O→4 NH₃+3O₂ (3)

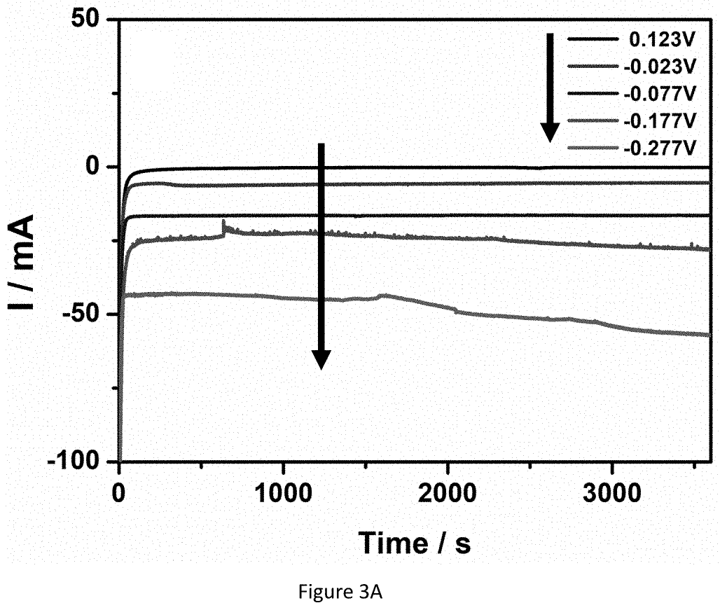

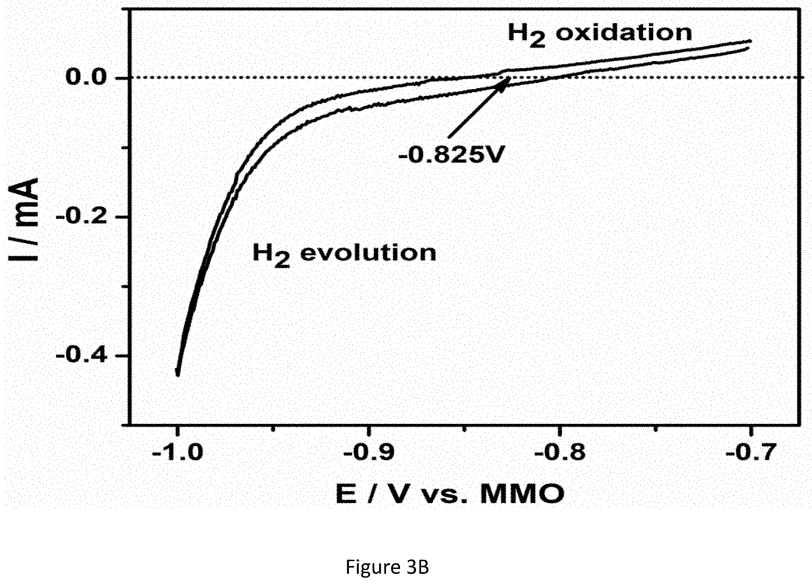

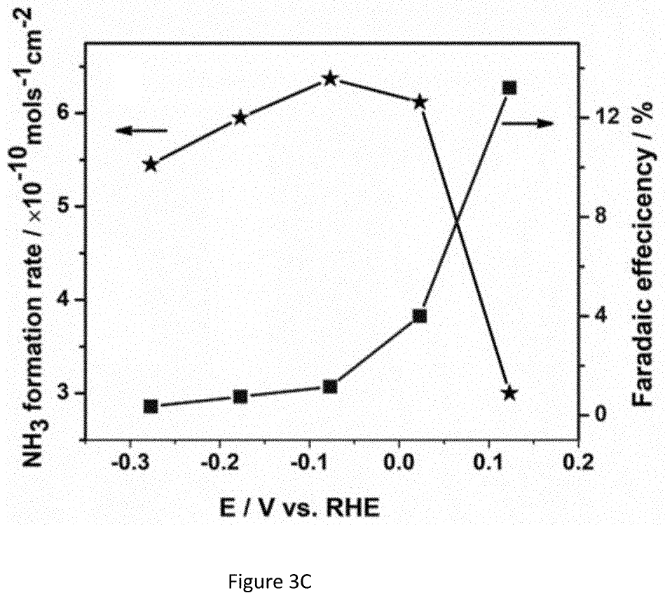

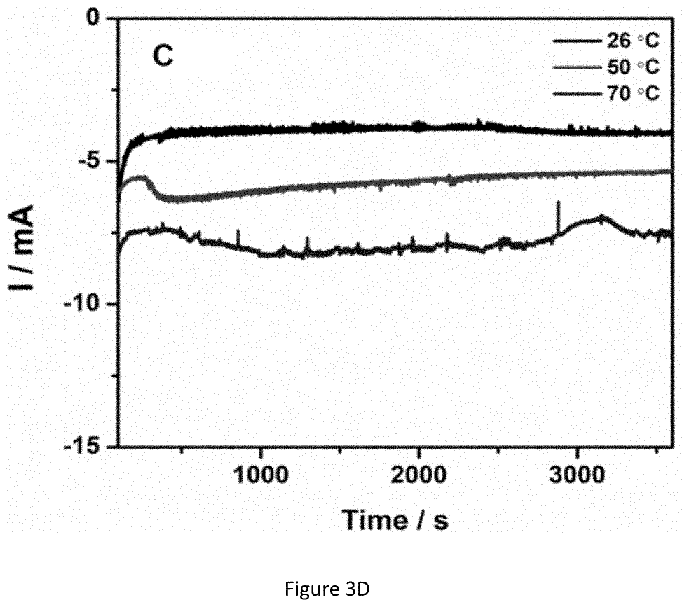

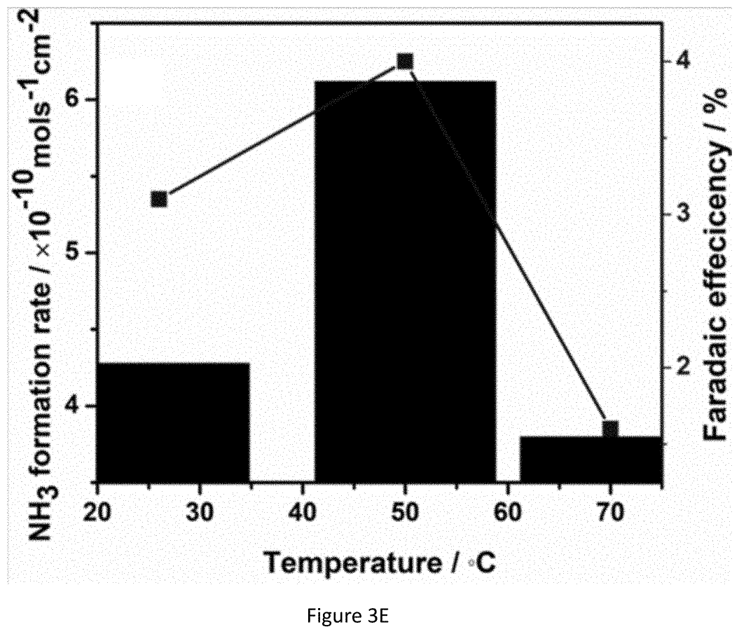

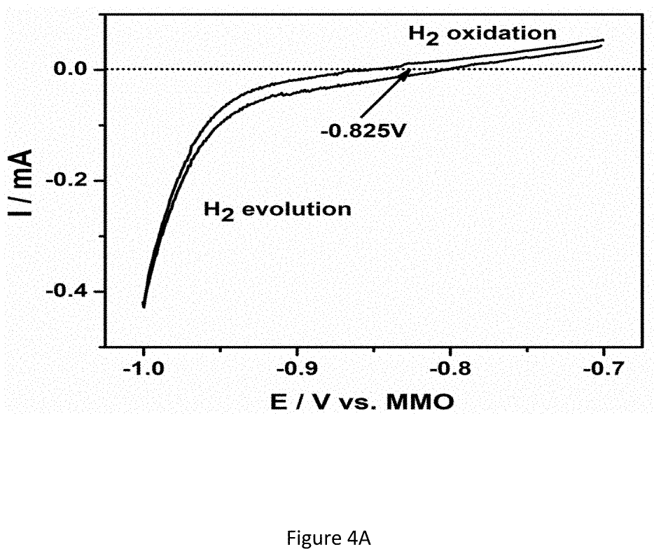

FIG. 3A depicts the effect of various applied potentials towards NRR at RuPt/C electrode in the cell configuration described above. In the present work all the potentials were measured versus MMO and converted into reversible hydrogen electrode (RHE) by calibration as shown in FIG. 3B. The rate of ammonia electrochemically formed and corresponding Faradaic efficiency at different applied potentials are given in FIG. 3C and summarized in Table 1. A maximum faradaic efficiency of 13.2% was observed at an applied potential of 0.123 V with rate of ammonia formation of 3.0×10⁻¹⁰ mols⁻¹cm⁻². On contrary, at −0.077V maximum amount of ammonia produced (6.37×10⁻¹⁰ mols⁻¹cm⁻²) with the Faradic efficiency of 1.1%. Indeed these obtained results were quite comparable than previously reported articles with similar reaction conditions as shown in Table 2.

TABLE 1
Effect of applied potential on electrochemical ammonia synthesis

| Applied | Quantification of | | | Efficiency |
|---|---|---|---|---|
| Potential | ammonia using | Ammonia | Ammonia | of |
| E/V vs. | Nesslers reagent/ | formation | formation | ammonia |
| RHE | mols⁻¹cm⁻² | (Theoretical) | (Experimental) | produced/% |
| 0.123 | 3.0 × 10⁻¹⁰ | 0.136 mg | 0.018 mg | 13.2 |
| 0.023 | 6.12 × 10⁻¹⁰ | 0.936 mg | 0.037 mg | 4 |
| −0.077 | 6.37 × 10⁻¹⁰ | 3.3 mg | 0.038 mg | 1.15 |
| −0.177 | 5.95 × 10⁻¹⁰ | 4.78 mg | 0.036 mg | 0.75 |
| −0.277 | 5.45 × 10⁻¹⁰ | 9.56 mg | 0.033 mg | 0.35 |

TABLE 2
Comparison of various catalysts used for electrochemical ammonia
synthesis under similar conditions

| | Yield of | Method used | | |
|---|---|---|---|---|
| | NH₃ g_{NH3} | for NH₃ | | |
| Catalyst | s⁻¹cm⁻² | quantification | Conditions | Reference |
| Ru based | 3.57 × 10⁻¹⁰ | phenate method | 20-90° C. | Kordali |
| electrode | | | and | et al. |
| | | | atmospheric | Chem. |
| | | | pressure | Commun. |
| | | | | (2000) |
| | | | | 1673. |
| Fe₂O₃-CNT | 6.11 × 10⁻¹⁰ | ammonia ion | Room | Bao et al. |
| | | selective | temperature | Adv. Mater. |
| | | electrode and | and | 29 |
| | | spectrophotometry | atmospheric | (2017) 1. |
| | | measurement with | pressure | |
| | | salicylic acid | | |
| Au-nanorods | 4.57 × 10⁻¹⁰ | Nessler's reagent | Room | Li et al. Nat. |
| | | And ammonia | temperature | Chem. 4 |
| | | colorimetric | and | (2012) 934. |
| | | assay kit | atmospheric | |
| | | | pressure | |
| Amorphous | 2.3 × 10⁻⁹ | Indophenol | Room | Kitano et al. |
| Au | | blue method | temperature | Nat. Chem. |
| nanoparticles | | | and | 4 (2012) |
| on CeOₓ- | | | atmospheric | 934 |
| RGO support | | | pressure | |
| Au-subnano | 5.9 × 10⁻⁹ | Indophenol | Room | Bielawa |
| clusters on | | blue method | temperature | et al. |
| TiO₂ | | | and | Angew. |
| | | | atmospheric | Chemie-Int. |
| | | | pressure | Ed. 40 |
| | | | | (2001) |
| | | | | 1061. |
| RuPt/C | 1.04 × 10⁻⁸ | Nessler's reagent | 50° C. and | Present |
| | | | atmospheric | disclosure |
| | | | pressure | |

The ammonia formation rate increased from potential 0.123 to −0.077 V and then decreased. However, Faradaic efficiency decreased as the applied potential increased. This illustrates that at relatively lower potential nitrogen reduction reaction was predominating which competes with by hydrogen evolution at higher potential.

The rate of NRR was measured at 30, 50 and 70° C. as shown in FIG. 3D. Electrochemical ammonia formation increases from 30 to 50° C. increasing temperature but slightly decreases at 70° C. FIG. 3E presents the rate of ammonia formation and Faradaic efficiency at various temperatures. Dissolved ammonia tests using Nessler reagent confirmed the presence of ammonia in the electrolyte, which is formed in the course of electrochemical nitrogen reduction. At 70° C. the solubility of ammonia in electrolyte significantly decreases from 3×10⁻¹⁰mols⁻¹cm⁻² to 9×10⁻¹¹mols⁻¹cm⁻². The concentration of ammonia in alkaline solution decreases as the temperature increases, for instance, ammonia solubility was decreased from 39.54 g/Liter to 19.71 g/Liter when temperature was raised from 50 to 70° C.

Specificity and Stability of RuPt/C

Without being bound by any particular theory, the associative and dissociate reaction mechanisms are two possible pathways proposed for nitrogen reduction reaction to form ammonia. Though theoretically both mechanisms are feasible depending on metal surface there are no experimental evidence which can specifically explain either one or both the mechanisms. However, during course of nitrogen reduction reaction, hydrazine may also be produced along with ammonia as seen on tetrahydral gold nanorods surface via the following reaction.

*N₂→*NNH→*NHNH→*NHNH₂→*NH₂NH₂→NH₂NH₂+* (4)

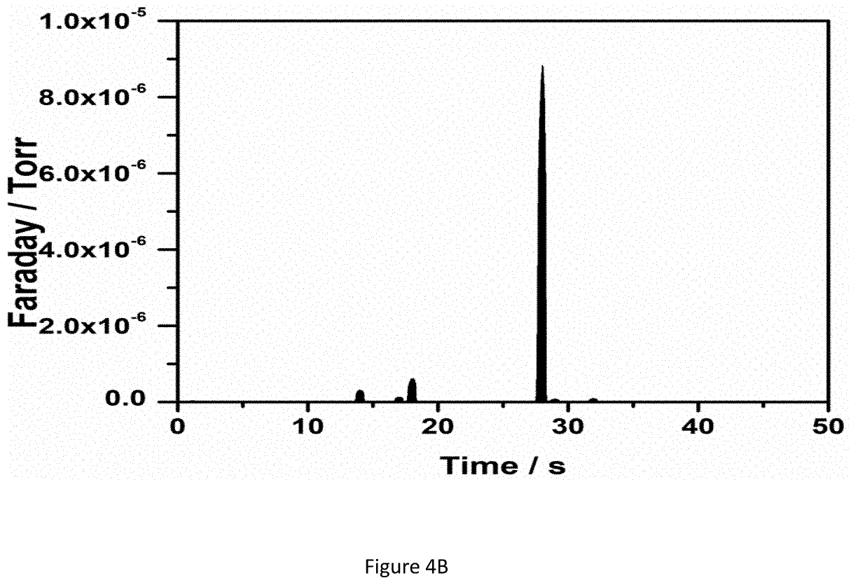

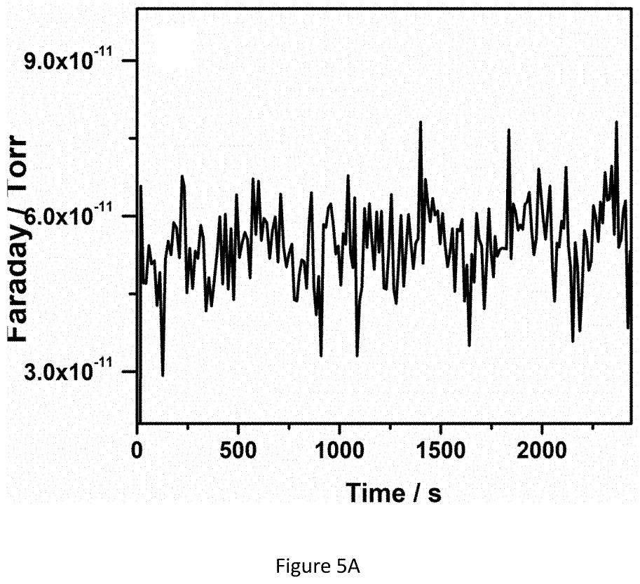

Selectivity study of ammonia formation on RuPt/C was carried out by analysis of the gas stream evolving from the cathode during the reaction. Out coming gas mixture was sampled on line and introduced to a mass spectrometry analyzer. A Mass spectrum of the gas stream produced at 50° C. under open circuit potential of 0.06 V is shown in FIG. 4 the fragment ions at m/z 17 and 18 assigned for water vapors. Similarly, nitrogen fragment ions found to be at m/z 14 and 28.

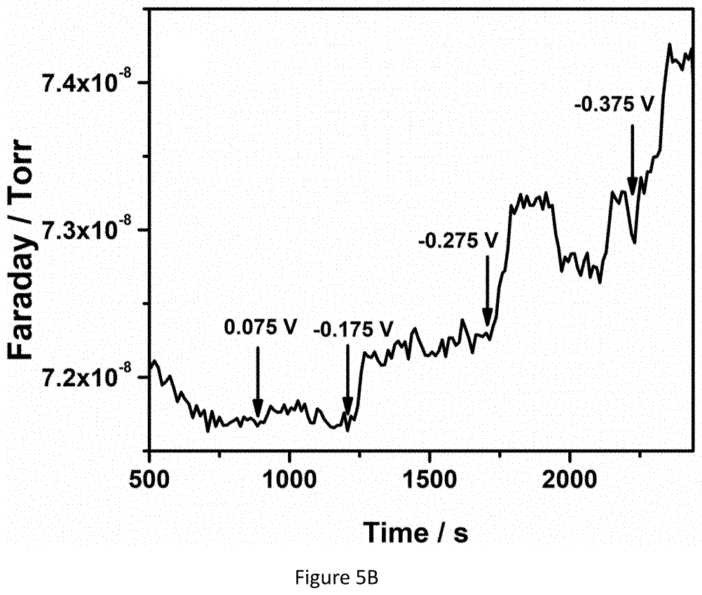

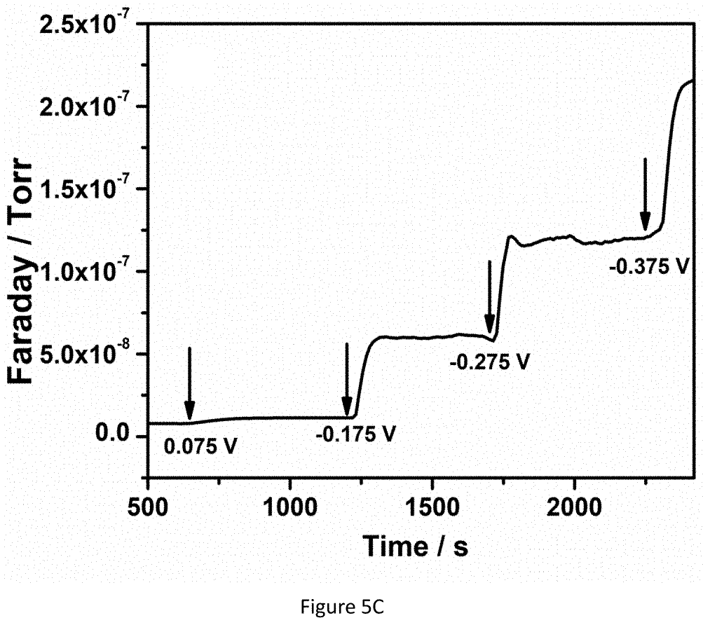

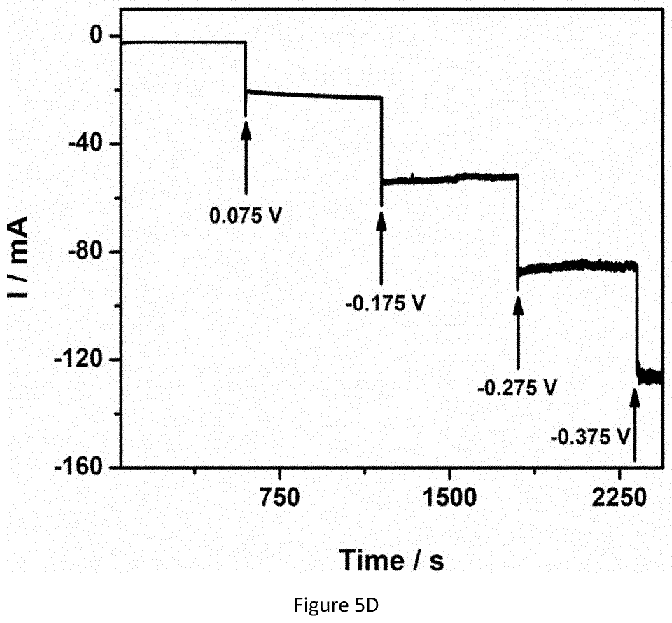

In the present disclosure multi ion detection mode has been employed to detect hydrazine, ammonia and hydrogen by applying their corresponding masses. FIGS. 5A, B and C show mass M⁺ of detection of hydrazine (M⁺=31), ammonia (M⁺=17) and hydrogen (M⁺=2), respectively. There are abrupt change upon change in the applied potential ranging from 0.075 to −0.375 V (FIG. 5D) correlating the current with ammonia and hydrogen gas evolution. On the other hand, there was no change in the hydrazine trace at this potential and depicted a signal of very low intensity compare to ammonia.

It can be concluded that no NRR reaction proceeds via hydrazine formation as a stable final product of nitrogen reduction. Furthermore, as the potential increased from 0.075 to −0.375 V the ammonia and hydrogen gasses were liberated in electrochemical cell and they were detected in mass spectrometry as shown in FIGS. 5B and C, respectively.

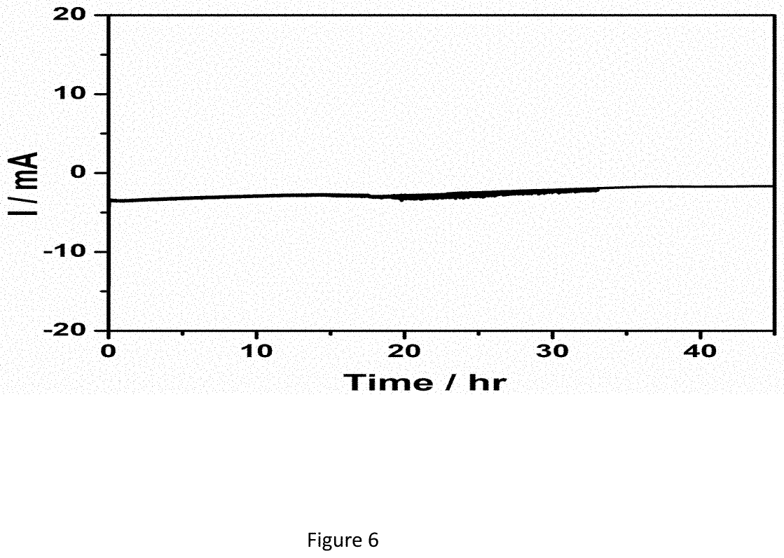

For practical applications, stability of the catalyst is one of the important parameters. To ascertain stability of RuPt/C electrode chronoamperometric test was carried out. FIG. 6 depicts that RuPt/C demonstrate decent stability for nitrogen reduction reaction up to 45 long hours. There was ca. 58% retention in current efficiency after 45 hours which suggests that RuPt/C electrode showed appreciable stability.

Taken together, RuPt/C was used as catalyst for electrochemical synthesis ammonia using water and nitrogen at ambient pressure and lower temperature. The linear sweep voltametric experiments of Ru/C, Pt/C and RuPt/C clearly depicted that the latter showed superior nitrogen reduction reaction activity. Thus, the high rate of ammonia formation was due to synergistic effect of RuPt alloy. Both temperature and applied potential have significant influence on the rate of ammonia formation. The present catalyst showed better stability and specificity towards nitrogen reduction reaction to form ammonia.

### Example 3

### Materials and Methods

Iron nitrate nonahydrate was purchased from Strem Chemicals. Vulcan XC-72 was procured from Cabot. Potassium hydroxide, isopropyl alcohol, concentrated ammonia solution (28 wt. %), titanium dioxide (325 mesh anatase) and nickel foil were procured from Aldrich. Fe₂O₃/TiO₂/C ink was prepared by mixing the catalyst, Vulcan XC-72 carbon and Nafion® (84, 8 and 8 wt. %, respectively) in a glass vial, with water and isopropyl alcohol (1:1 v/v) added to the mixture. This slurry was stirred overnight on a magnetic stirrer, brush-coated onto nickel foam and dried at 90° C. for 2 h in an air-convection oven. The commercials catalysts such as titanium powder, titanium nanoparticles, titanium hydride were purchased from Strem Chemicals. Platinum black, palladium black and ruthenium platinum alloy were procured from Alfa Aesar. The anionic membranes (quaternary ammonium polysulfone, thickness 40 μm) were bought from Hephas Energy Co. Ltd.

Synthesis of Fe₂O₃/TiO₂

6 mmol (2.4 g) of iron(III)-nitrate nonahydrate was dissolved in 30 ml of distilled water. To this reaction mixture, 0.18 g of titanium dioxide was added and sonicated for 10 minutes. The mixture was placed on a magnetic stirrer, and 7 ml of concentrated ammonia solution (28-30 wt. %) was added dropwise under constant stirring until pH 10 was reached (indicating a small excess of ammonia solution). During the synthesis the light-yellow reaction mixture turned to a thick dark-brown slurry. This product was heated gradually up to 80° C. for 2-3 hours until the ammonia smell disappeared. The resulting thick mass was transferred into a hydrothermal bomb, and an appropriate amount of water was added until 70% of the total volume of the hydrothermal bomb was filled with liquid. Finally, the hydrothermal reaction was carried out at 100° C. for 15 hours. After that, the reaction mixture was cooled down to room temperature. The final product was filtered and washed extensively with MilliQ® water to remove the ammonium nitrate formed during the reaction (complete removal of ammonium nitrate was confirmed by Nessler's reagent). The obtained product was dried at 80° C. overnight as previously described. The Fe³⁺ ions were precipitated as hydrated iron(III) oxide under the alkaline condition, and the obtained product was further transformed into FeOOH, as shown in Reactions (1) and (2), respectively. Under heating, the Fe(III)OOH was converted into Fe₂O₃, as given in Reaction (3).

Fe³⁺_{(aq)}+3NH_{3(aq)}+3H₂O₍ₗ₎→Fe(OH)₃₍ₛ₎+3NH₄⁺_{(aq)} (1)

Fe(OH)₃₍ₛ₎→FeOOH₍ₛ₎H₂O₍ₗ₎ (2)

2FeOOH₍ₛ₎→Fe₂O₃+H₂O₍ₗ₎ (3)

### Instrumentation and Methods

A BioLogic VSP potentiostat was used in all electrochemical experiments. A Hiden Analytical HPR-20 mass spectrometer was used for qualitative analysis of gases. The electrochemical experiments were performed using a three-electrode system consisting of Fe₂O₃/TiO₂/C-coated nickel foam as a working electrode, nickel foil as a counter electrode and mercury/mercury-oxide (MMO, 1.0 M KOH) as a reference electrode. A 1.0 M KOH solution was used as an electrolyte in all experiments. All the potentials were measured versus a mercury/mercury-oxide reference electrode and converted by calibration method into a potential versus reversible hydrogen electrode (RHE). When nickel foil was used as the working electrode (even at high overpotentials) there was no detectable ammonia oxidation. Therefore, pure nickel foil was used as a counter electrode in the present work without a risk of possible consumption of electrochemically produced ammonia. The dissolved oxygen was removed from the electrolyte by purging with argon gas (99.999% pure) for 20 min. For electrochemical synthesis of ammonia, high-purity nitrogen gas (99.999% pure) was purged prior to the experiment for 20 min. The electrochemically produced ammonia gas was trapped in a 1 mM H₂SO₄ solution, and the rate of ammonia formation was calculated using the following equation (Equation 4):

$${r}_{NH 3} = \frac{[ {NH}_{4}^{+} ] \times V}{t \times A} \qquad ( 4 )$$

where: [NH4+] is the measured ammonium ion concentration, V is the volume of solution used for ammonia collection, t is the time of electrochemical reaction, and A is the area of the working electrode. During the electrochemical reaction a constant flow of either nitrogen or air was introduced into the cell at a flow rate of 50 cm3 min−1. At the applied potential, nitrogen gas was reduced into ammonia at the cathode, as shown in FIG. 2A. The acid trap and the alkaline electrolyte solutions were used for the quantification of electrochemically produced ammonia by adding Nessler's reagent and measuring the absorbance at 420 nm (FIG. 2A). The exact ammonia concentration was determined by linear regression (5-point calibration curve). The final amount of ammonia obtained from NRR was calculated by adding the ammonia content found in the acid trap to that present in the alkaline electrolyte.

Characterization of Fe₂O₃/TiO₂

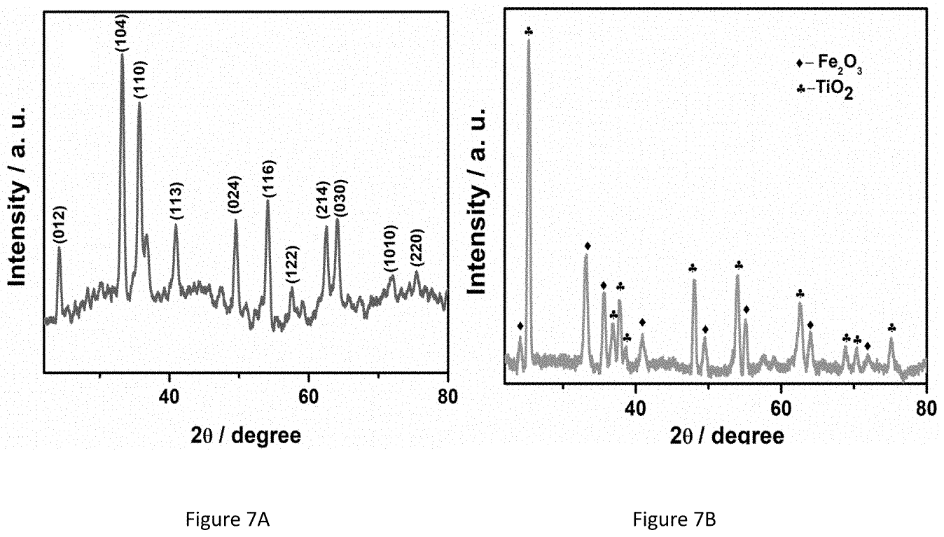

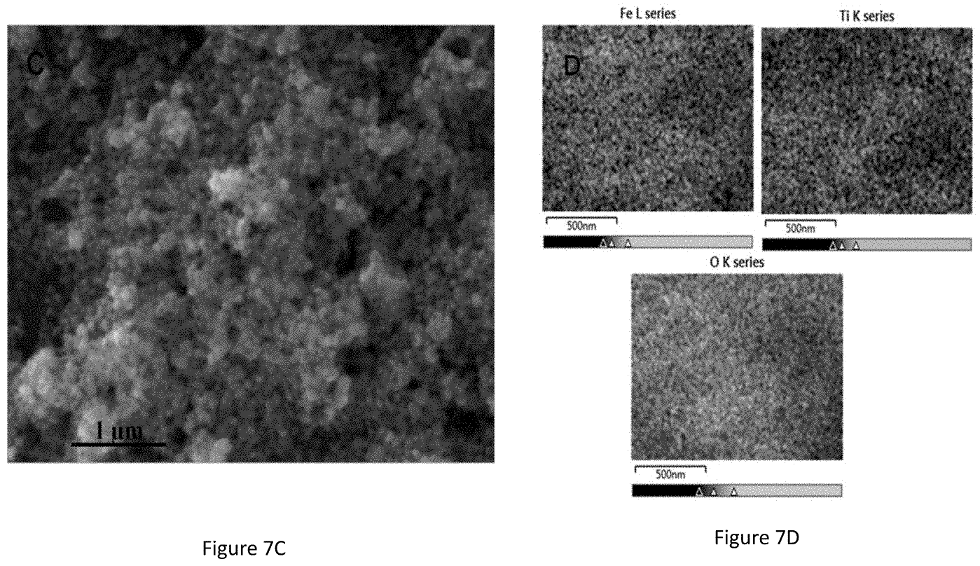

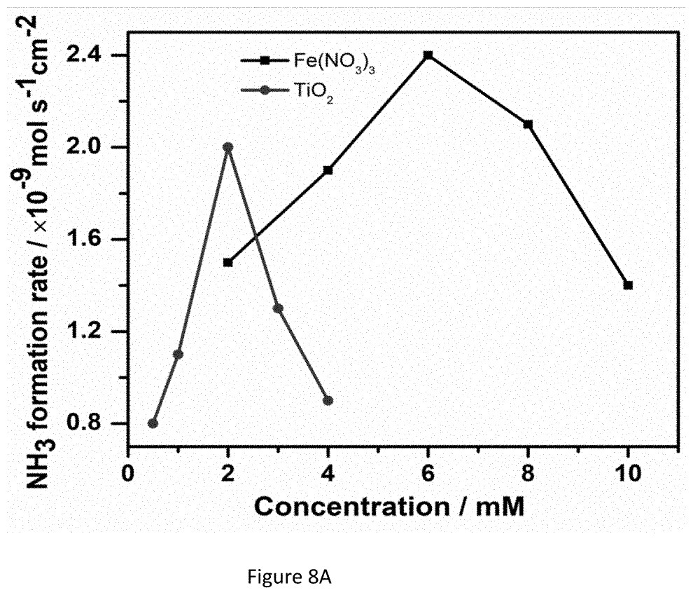

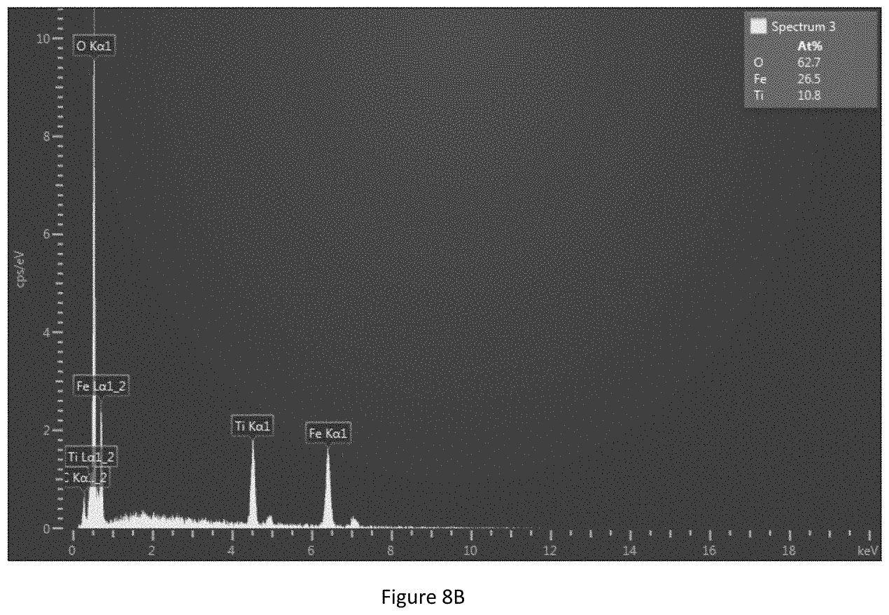

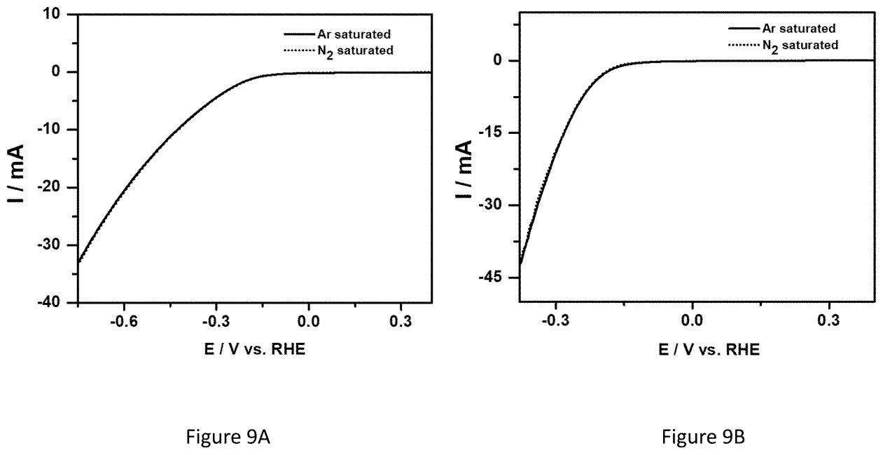

Fe₂O₃ powder was synthesized by using the aforementioned synthesis protocol in ammonia solution. FIGS. 7A-B show the X-ray diffraction patterns of Fe₂O₃ and TiO₂-based composites, respectively. The peaks at 24.14, 33.16, 35.60, 40.83, 49.45, 54.08, 62.43 and 63.99° (FIG. 7A) show good agreement with the literature data corresponding to Fe₂O₃ (No. 33-0664: a=5.0356 Å, c=13.7489 Å). On the other hand, the 2-theta peaks at 25.27, 37.77, 48.01, 53.88, 55.03, 62.66, 68.78, 70.30 and 75.04° correspond to the (101), (004), (200), (105), (211), (204), (116), (220) and (215) planes of an anatase crystalline TiO₂ phase (FIG. 1B). According to Equations 2 and 3, FeOOH particles were formed during the addition of ammonia solution to the suspension of TiO₂ support and were then converted to a crystalline Fe₂O₃ phase during the hydrothermal treatment. FIGS. 7C-D show SEM and EDX mapping of the Fe₂O₃/TiO₂ composite. The SEM image shows the aggregate of Fe₂O₃ particles on the surface of the underlying TiO₂ (40 microns). According to the results of EDX mapping, Fe₂O₃/TiO₂ composites contain 26.5 and 10.8 atomic % of Fe and Ti, respectively. The optimal ratio of starting materials (i.e. 6 mmol Fe(NO₃)₃ and 2 mmol TiO₂) is optimized by determining the highest ammonia formation ratio for different amounts of iron(III) nitrate and titanium dioxide used for the synthesis of the catalyst, as shown in Figure S5. By using the experimentally determined optimal ratios of the precursors, the atomic ratios of Fe, Ti and O were theoretically calculated to be 28, 9.5 and 62%, respectively. These values are very close to the ratio found by EDX analysis (as given in FIG. 8), proving that the optimal composition of the catalyst was used in this work.

### Electrochemical Measurements

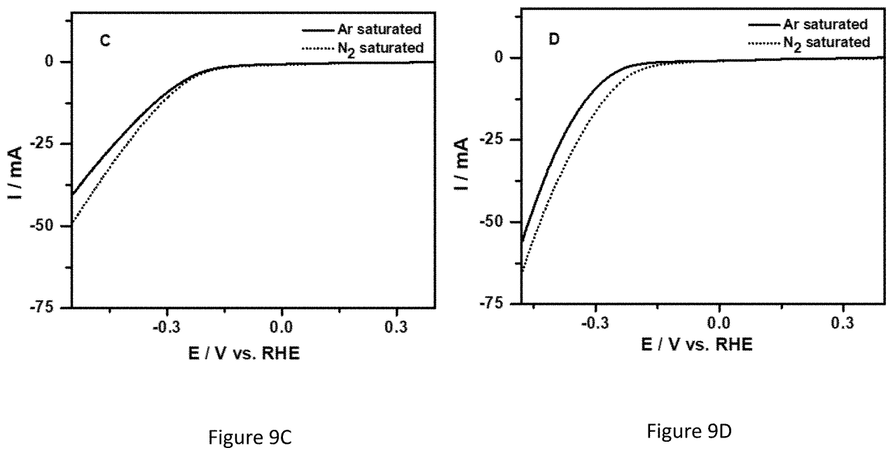

Linear sweep voltammograms (LSVs) of the nickel-foam working electrodes in a 1.0 M KOH-saturated solution are shown in FIG. 9A. There was no obvious change in LSVs when bare nickel foam was used as a working electrode in either argon or nitrogen-saturated electrolytes. Therefore, nickel foam can be used as an excellent substrate, due to its high porosity and electrochemical inertness towards NRR in the potential window applied. Similarly, the TiO₂/C electrode did not show any NRR in the presence of the N₂-saturated electrolyte, as shown in FIG. 9B. However, the Fe₂O₃-coated nickel-foam electrode (loading: 15 mg cm⁻²) in the nitrogen-saturated 1.0 M KOH solution exhibited an increase in the reduction current without any significant change in onset potential (−0.183 V vs. RHE), in contrast to the argon-saturated electrolyte. Nevertheless, the rate of ammonia formation on the Fe₂O₃-coated Ni-foam electrode was 2×10⁻¹⁰ mol s⁻¹cm⁻² at an applied potential of −0.277 V vs. RHE. The onset potential of HER recorded in the argon-saturated solution on the Fe₂O₃/TiO₂ composite electrode was −0.2 V. That value is lower than the onset for NRR obtained from the LSV recorded under nitrogen saturation (from −0.2 V in Ar to −0.15 V in N₂); conditions showed a 0.05 V difference in onset potentials between these two processes when argon was replaced by nitrogen. Furthermore, a clear decrease of −0.027 V in the overpotential was seen between the voltammograms recorded using Fe₂O₃/TiO₂/C and Fe₂O₃/C in the nitrogen-saturated solution, showing the enhanced activity of the former one. These results confirmed that the synergistic effect of Fe₂O₃/TiO₂ composite plays an important role in enhancing the electrochemical ammonia reaction. In the catalyst employed in this work, the molar ratio between Fe₂O₃ and TiO₂ was 60% and 40%, respectively, as calculated from the starting amounts of iron(III) nitrate and titanium dioxide. The rate of ammonia formation was found to be almost one order of magnitude higher on the TiO₂-supported catalyst (1.2×10⁻⁹ mol s⁻¹cm⁻²) compared to an unsupported iron-oxide catalyst (2.0×10⁻¹⁰ mol s⁻¹cm⁻²) at an applied potential of −0.277 V vs. RHE. The rate further increased to 1.9×10⁻⁹ mol s⁻¹cm⁻² with the same loading when 10 wt. % of Vulcan-XC carbon was added to improve the electron charge transfer process between the catalyst and the current collector. As mentioned earlier, a few research articles have already reported iron-based catalysts for NRR, but at elevated temperatures and pressures. The higher electrocatalytic activity of Fe₂O₃/TiO₂ for NRR cannot be explained solely by the activity of Fe₂O₃ alone. Therefore, it can be concluded that the presence of TiO₂ in the composite seems to have a significant effect on the catalysis. Indeed, the ammonia formation rate of −0.277 V obtained with the Fe₂O₃/TiO₂ composite was almost one order of magnitude higher, compared to Fe₂O₃ only. Both naturally occurring and synthetic forms of TiO₂ have a small oxygen deficiency; therefore, the exact formula of the titanium dioxide can be expressed as TiO₂₋ₓ(x˜0.01) in both anatase and rutile forms. This oxygen deficiency is due to the presence in both forms of a small amount of Ti³⁺ impurity in the titania crystalline structure. For instance, Hirakawa et al. have used commercial anatase as a photocatalyst for ammonia synthesis from water and nitrogen at atmospheric pressure and room temperature. The photocatalytic activity of the TiO₂ was attributed to the Ti³⁺ surface species serving as active sites for nitrogen reduction. Hence, it was assumed that the inherently present Ti′ species in TiO₂ facilitate the adsorption and reduction of nitrogen molecules via the electron donation and cleavage of N≡N. This leads to the formation of the Ti⁴⁺-azo complex; the Ti³⁺ species are regenerated by the formation of ammonia during photocatalysis. Similar enhancement of ammonia formation was reported at the surface of some noble metals (Pt, Ru and Pd) loaded onto TiO₂ that were used as photocatalysts and contrasted favorably with their unsupported homologues. Titania alone does not have any electrocatalytic activity (FIG. 9B), but when used as support for Fe₂O₃ it shows superior electrocatalytic performance. In the present work the inventors assumed that not only Fe₂O₃ but also TiO₂ (carrying the Ti′ species) surgically responsible for NRR.

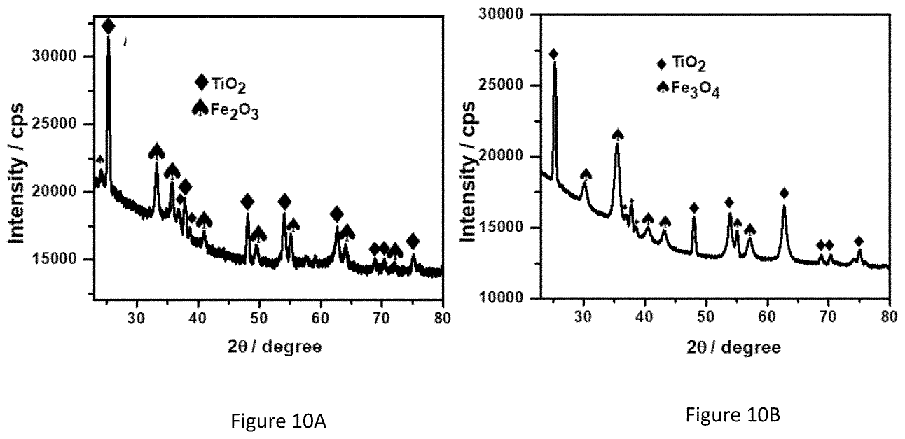

The proposed underlying mechanism for such experimental observation could be as follows: By polarizing a cathode to such negative electrode potentials, it can be expected that iron(III) oxide will be partially reduced to form magnetite (FeO.Fe₂O₃). This has been experimentally proven by recording the XRD of a catalyst layer after the electrode was kept at −0.277 V vs. RHE (as shown in FIG. 10A-B), during which time the characteristic Fe₂O₃ XRD pattern completely disappeared. This kind of electroreduction has already been reported for the electrochemical reduction of a Fe₂O₃ pallet in a two-electrode cell configuration operating at 1.61 V in 60% NaOH at 110° C. The XRD of the obtained product clearly showed the existence of a magnetite phase along with excess Fe₂O₃ and elemental iron. The possible underlying mechanism for the synergic behavior between Fe₂O₃ and TiO₂ regarding the NRR could be understood as based on the interfacial intervalence charge transfer between Ti⁴⁺ (from TiO₂) and the Fe²⁺ species that are formed during the partial electroreduction of the iron (III) oxide catalyst. Such phenomena were reported earlier for various Fe—Ti containing minerals. This kind of electron exchange might result in regeneration of the Fe₂O₃ catalyst and the concomitant formation of Ti′ species that present additional active sites for NRR, as mentioned before.

### The Effects of Applied Electrode Potential and Temperature

The effects of applied electrode potentials and temperature on the rate of ammonia formation at a Fe₂O₃/TiO₂ composite modified electrode were studied by chronoamperometry in alkaline electrolyte. At an applied potential nitrogen was reduced to ammonia at the cathode, in an overall process described in Reaction (5), while the oxygen evolution occurred on the surface of the counter electrode (Reaction (6)). The obtained ammonia was partially dissolved in alkaline electrolyte while the remaining amount was introduced into the acid trap by the gas carrier (i.e. the unreacted nitrogen stream).

Cathode: 2N₂+12H₂O+12e⁻→NH₃+12 OH⁻ (5)

Anode: 12 OH⁻→3O₂+6H₂O+12e⁻ (6)

Overall: 2N₂+6H₂O→NH₃+3O₂ (7)

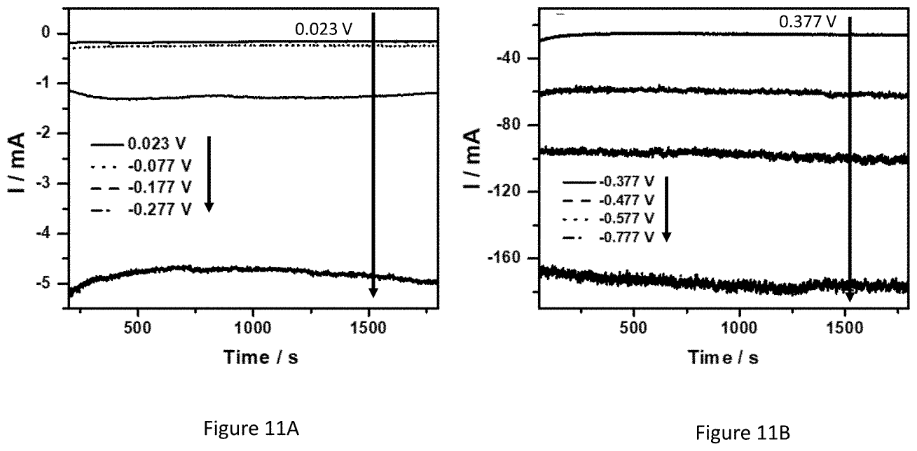

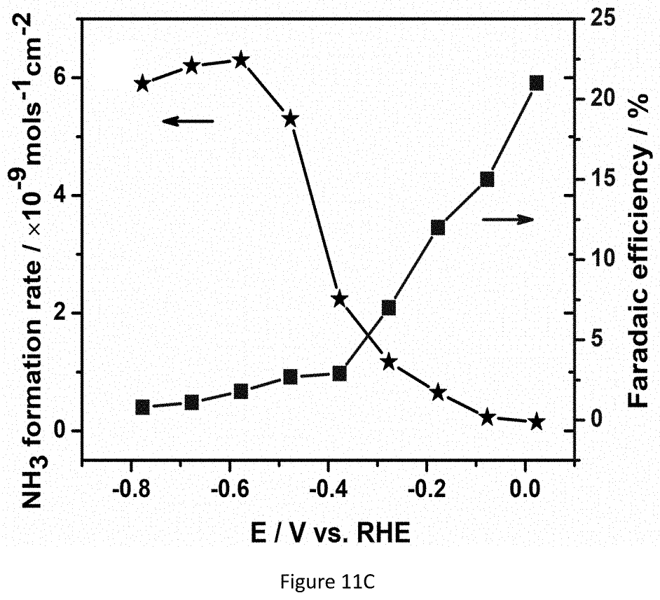

FIGS. 11A and 11B depict the influence of selected applied potentials on NRR at the Fe₂O₃/TiO₂ catalysts. The various ammonia electrochemical formation rates and their corresponding faradaic efficiencies are given in FIG. 11C and summarized in Table 3.

TABLE 3
Effect of applied potential on electrochemical ammonia synthesis

| | Quantification | | | |
|---|---|---|---|---|
| Applied | of ammonia | Ammonia | Ammonia | |
| Potential | using Nessler's | formation | formation | |
| (mV vs. | reagent | Theoretical* | Experimental** | Efficiency |
| RHE) | (mol s⁻¹cm⁻²) | (mg) | (mg) | (%)*** |
| 23 | 1.5 × 10⁻¹⁰ | 0.041 | 0.009 | 21 |
| −77 | 2.3 × 10⁻¹⁰ | 0.082 | 0.013 | 15 |
| −177 | 6.5 × 10⁻¹⁰ | 0.31 | 0.039 | 12 |
| −277 | 1.9 × 10⁻⁹ | 1.45 | 0.11 | 7 |
| −377 | 2.4 × 10⁻⁹ | 5.2 | 0.14 | 2.7 |
| −477 | 5.3 × 10⁻⁹ | 10.8 | 0.32 | 2.9 |
| −577 | 6.3 × 10⁻⁹ | 20.3 | 0.38 | 1.8 |
| −677 | 6.2 × 10⁻⁹ | 33.2 | 0.37 | 1.1 |
| −777 | 5.9 × 10⁻⁹ | 46.8 | 0.36 | 0.8 |

*Calculated using Equation SE2.
**Calculated based on experimental results (Equation 4).
***Calculated based on experimental results by using Equation SE2.

A maximum faradaic efficiency of 21% was observed at a low applied potential of 0.023 V with a slow ammonia formation rate of 1.5×10⁻¹⁰ mol s⁻¹cm⁻². The maximum rate of ammonia formation of 6.3×10⁻⁹ mol s⁻¹ cm⁻² was attained at a high applied potential of −0.577 V with a faradaic efficiency of 1.8%. As applied potential increased from −0.577 V to −0.777 V, both the rate of ammonia formation and faradaic efficiency declined and finally reached a value of 5.9×10⁻⁹ mol s⁻¹ cm⁻² and 0.8%, respectively. This illustrates the competition between NRR and HER predominantly at high potentials, giving rise to low faradaic efficiencies observed at potentials below −0.377 V. The obtained results are comparable with both iron-based (nano-Fe₂O₃, γ-Fe₂O₃, nano-Fe₃O₄, and CoFe₂O₄) and non-iron-based catalysts (Ru/Cs⁺/MgO and BaCe_{0.9}Y_{0.1}O_{3-δ}), which were reported earlier for the systems that operate at relatively high temperatures (as shown in Table 1).

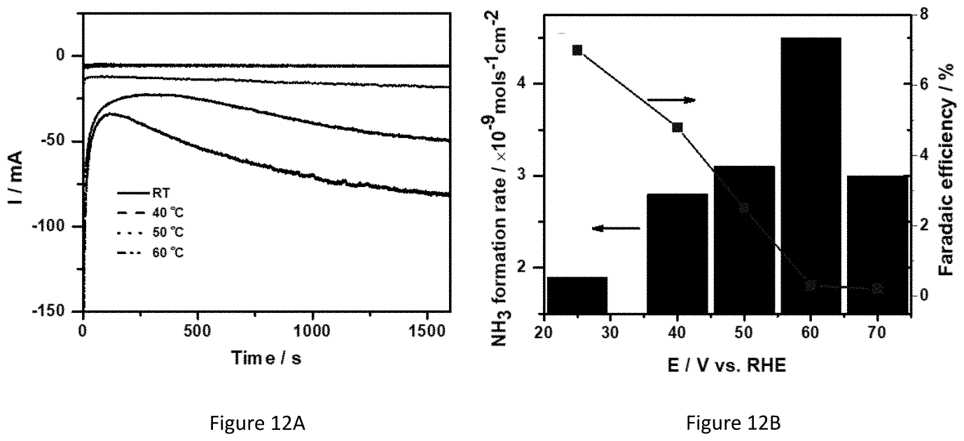

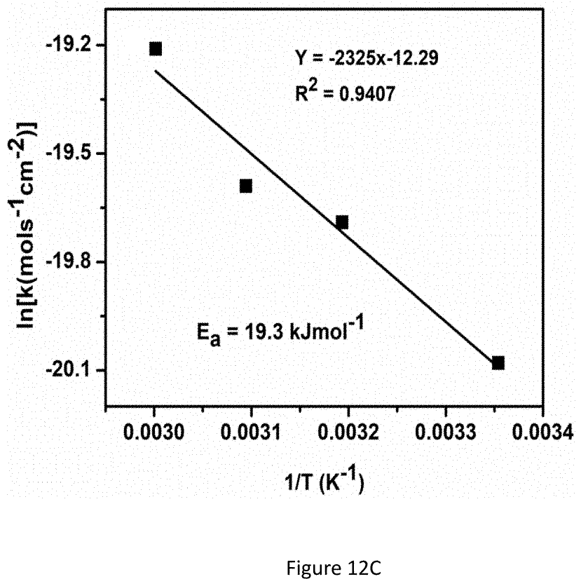

The effect of temperature on the rate of NRR was studied by varying temperature from 25 to 60° C. at a potential of −0.277 V, as shown in FIG. 12A. It can be seen that the electrochemical ammonia formation rate increased with increasing reaction temperatures up to 60° C. As temperature was increased, the heterogeneous rate constant for NRR increased simultaneously, and as a result the rate of ammonia formation was increased, with a concomitant decrease in the faradaic efficiency due to the dominant HER above 60° C.

Temperatures above 60° C. might have a stronger impact on HER than NRR. Hence, at temperatures above 70° C. the competing hydrogen evolution starts to dominate the overall electrochemical process. The variations in ammonia formation rate and faradaic efficiency at various temperatures are given in FIG. 12B and summarized in Table 4. By using an Arrhenius plot and fitting the ln(rate) versus 1/T (FIG. 12C), the activation energy for nitrogen reduction was found to be 19.3 kJ mol⁻¹ (based on Equation SE1).

TABLE 4
Effect of temperature on electrochemical ammonia synthesis.

| | Quantification of | Ammonia | Ammonia | |
|---|---|---|---|---|
| | ammonia using | formation | formation | |
| Temp | Nessler's reagent | Theoretical | Experimental | Efficiency |
| (° C.) | (mol s⁻¹cm⁻²) | mg | mg | % |
| 25 | 1.9 × 10⁻⁹ | 1.04 mg | 0.072 mg | 7 |
| 40 | 2.8 × 10⁻⁹ | 3.64 mg | 0.175 mg | 4.8 |
| 50 | 3.1 × 10⁻⁹ | 7.69 mg | 0.190 mg | 2.5 |
| 60 | 4.5 × 10⁻⁹ | 15.6 mg | 0.275 mg | 0.3 |
| 70 | 3 × 10⁻⁹ | 13.9 mg | 0.183 mg | 0.2 |

### Calculation of Activation Energy (Ea) Based on Experimentally Determined Ammonia Rate of Formation:

$$k = Ae \frac{- {E}_{a}}{R T} Arrhenius equation$$

$$ln k = \frac{- {E}_{a}}{R T} + ln A$$

$$slope = \frac{- {E}_{a}}{R}$$

$${E}_{a} = 2325.43 \times 8.314$$

$${E}_{a} = 19.3 kJ {mol}^{- 1}$$

where: A constant; R Universal gas constant (8.314 Jmol⁻¹K⁻¹); T—temperature (K); k—reaction rate.

### SE2. Calculation of the Theoretical Ammonia Formation Based on Faraday's Law:

$$m = \frac{M * I * t}{z * F}$$

Where: m—mass (g); M—Molar weight (g mol⁻¹); I—current (A); t—time (s); z—number of electrons (3); F—faraday constant (96486 C mol⁻¹)

### SE3. Calculation of Faradaic Efficiency:

$$FE ( \% ) = \frac{{NH}_{3} experimentaly found}{{NH}_{3} theoritical value} \times 100$$

Electrochemical Ammonia Synthesis from Air

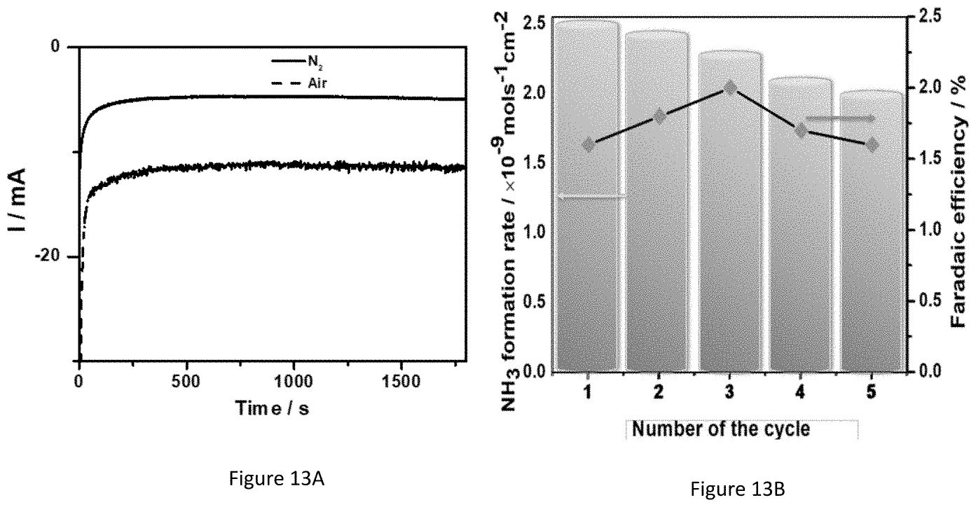

The air contains around 78% v/v nitrogen; thus, it presents an attractive source of molecular nitrogen that can be used for ammonia electrosynthesis. FIG. 13A shows chronoamperometric curves of the Fe₂O₃/TiO₂/C composite painted on nickel-foam electrodes in 1.0 M KOH solutions saturated with nitrogen and air at a potential of −0.277 V. Using air-saturated electrolyte yielded a rate of 1.7×10⁻⁹ mol s⁻¹cm⁻², a value comparable to the ammonia formation rate determined in nitrogen-saturated electrolyte (i.e. 1.9×10⁻⁹ mol s⁻¹ cm⁻² at −0.277 V). This proves the hypothesis that air can be used as an excellent substitute for pure nitrogen, regardless of the presence of other gases such as oxygen. Similarly, the faradaic efficiencies in nitrogen and air were found to be 7% and 3%, respectively. The obtained ammonia formation rate (1.9×10⁻⁹ mol s⁻¹cm⁻²) was very close to the rate of ammonia formation using pure nitrogen. However, high reduction current density (−11.14 mA cm⁻²) was observed in the air-saturated solution, which was attributed to the contribution of oxygen reduction reaction that occurred simultaneously with NRR on an iron-based catalyst.

### Stability Study

To evaluate the stability of Fe₂O₃/TiO₂/C composites on nickel-foam electrodes, repetitive potential-controlled NRR measurements were carried out with a time interval (cycles) of 30 minutes. Each experiment was conducted with the same electrode as the rate of ammonia formation was measured (shown in FIG. 13B). These cycles were applied to refresh the solutions of the electrolyte and the acid trap after the extraction of aliquots used for the analysis, in order to make sure that the amount of sulfuric acid in the trap was not completely neutralized by the ammonia stream but retained its trapping capacity. After each cycle, the working electrode was rinsed with water, dried, and fresh alkaline electrolyte was used to perform the subsequent NRR cycles. After five consecutive measurements, faradaic efficiency and rate of ammonia formation were found to be 2% and 2×10⁻⁹ mol s⁻¹ cm⁻², respectively. This shows that the ammonia production rate on this electrode remained stable over a period of 5 hours.

On-Line Direct Electrochemical Mass Spectrometric Measurement of Evolved Gases at the Fe₂O₃/TiO₂/C Electrode

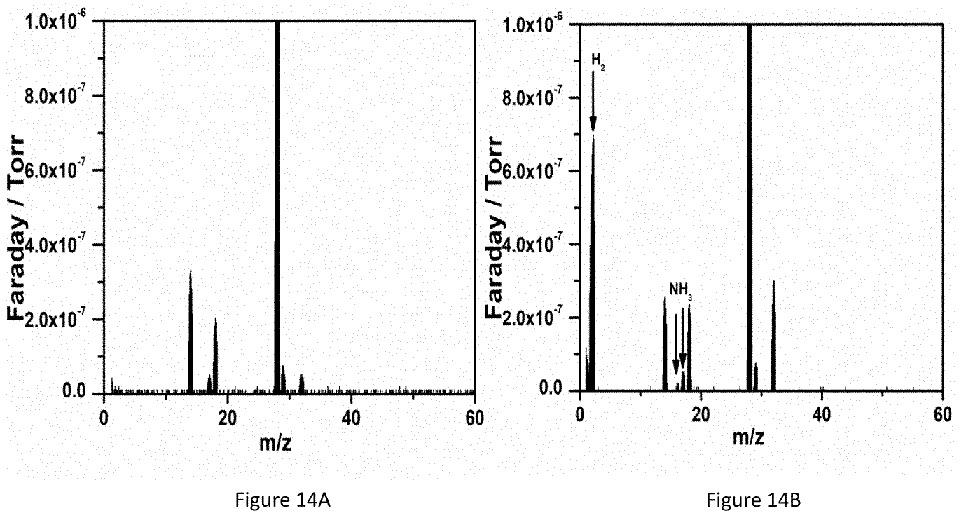

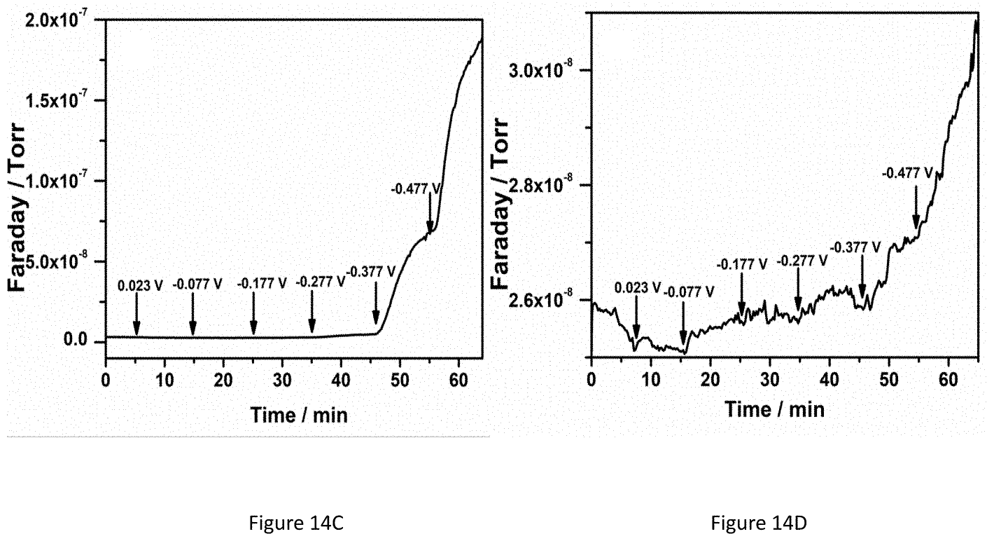

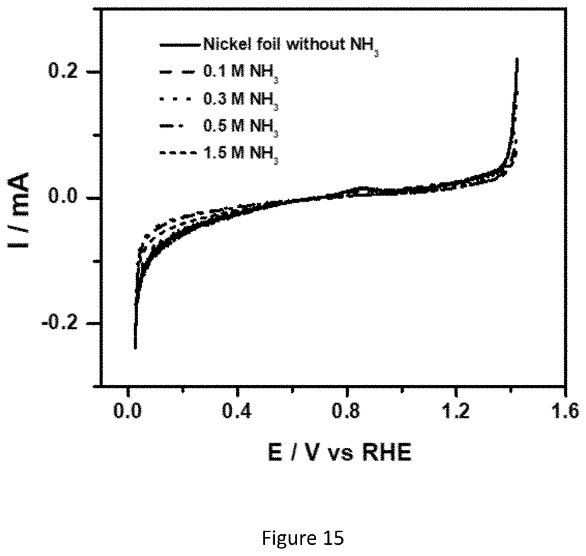

It is very important to know the chemical composition of the gas products evolved during the NRR. FIGS. 14A-B present the mass spectra of the outlet gas mixture, before and after the selected electrode potential (−0.477 V vs. RHE) was applied. At this applied potential, three gases were detected in a large window of mass-to-charge ratios (m/z), i.e. the m/z values of 2, 17 and 32 (corresponding to hydrogen, ammonia and oxygen, respectively). The simultaneous ammonia electro-oxidation that might take place on the counter electrode was ruled out, since no peaks that correspond to either NO or NO₂ (m/z=30) were found in the spectrum at this applied potential. These oxides could have been formed on the anodic electrode as a side-product in the oxidation of ammonia and water to N₂ and O₂, respectively. The inventors attributed this to the relatively high overpotential of ammonia oxidation on Ni foil (as seen in FIG. 15).

The highest faradaic efficiency of 21% was found at a potential of 0.023 V with a very low ammonia formation rate (FIG. 11A-C). The rate increased with the increasing value of electrode potential. At −0.477 V, the ammonia formation rate was significantly lower, with the HER being the most favorable process. Conversely, lower applied potentials gave the highest rate for NRR at the expense of a very low faradaic efficiency. Therefore, −0.477 V was selected for on-line DEMS studies, as shown in FIG. 15C; FIG. 15D shows the simultaneous measurements of hydrogen (m/z=2) and ammonia (m/z=17).

Fe₂O₃/TiO₂/C was used as a catalyst for electrochemical synthesis of ammonia, using water and nitrogen at ambient pressure and room temperature. The chronoamperometric and linear sweep voltammetric experiments on the Fe₂O₃/TiO₂/C clearly confirmed that Fe₂O₃ together with TiO₂ shows better nitrogen reduction reaction activity than Fe₂O₃ alone. The high rate of ammonia formation was due to the synergistic effect of iron oxide/TiO₂. Applied temperatures and electrode potentials showed a significant impact on the rate of ammonia formation. The present catalyst showed remarkable activity and good stability for NRR, even when air was used as the nitrogen source.

### Example 4

### Synthesis of Fe₂O₃/TiO₂/C

Fe₂O₃/TiO₂/C ink was prepared by mixing the catalyst, Vulcan XC-72 carbon and Nafion® (84, 8 and 8 wt. %, respectively) in a glass vial, with water and isopropyl alcohol (1:1 v/v) added to the mixture. This slurry was stirred overnight on a magnetic stirrer, brush-coated onto nickel foam and dried at 90° C. for 2 h in an air-convection oven.

### Synthesis of Ru@Fe/Fe₂O₃

In MeOH—H₂O (60 mL/140 mL), a solution of iron(II) sulfateheptahydrate (99%) (4.5 g in 200 mL H₂O) was reduced with aqueous NaBH₄ (0.8 g in 20 mL H₂O added at a rate of approximately 2 mL per minute). The resulting Fe/Fe₂O₃ were then washed three times with 10 mL of methanol, using a magnet to immobilize the particles. Afterward, a RuCl₃ solution was prepared (10 mg of RuCl₃ in 10 mL of methanol) and added dropwise to the sonicating solution of iron nanoparticles (100 mg in 10 mL). The resulting mixture was left to sonicate for 30 min. The supernatant was magnetically decanted, and the resulting Ru@Fe/Fe₂O₃ were rinsed three times with methanol (10 mL) and dried prior to use.

### RuPt-Ti

The equal amount of RuPt alloy and Titanium nanopowder were taken in mortar, ground well and obtained composition reduced at hydrogen argon mixture (20:80) at 350° C. for three hours.

Ru/TiO₂-Ti₂O₃

RuCl₃ and urea mixed well in the ratio 1:2 and transferred into Swagelok cell. To this mixture 1 equivalent weight of titanium isopropoxide added and the closed tightly heated at 500° C. for three hours. After reaction completion, cooled to room temperature and product taken out from the Swagelok cell.

### CFeMoBi

0.1 M BiCl₃, 0.03 M Na₂MoO₄ and 0.03 M FeCl₃ dissolved in 22 ml Milli-Q water. To this mixture 0.3 g of black pearl carbon added. Finally 7.5 ml of ethylene glycol and 40 ml of ethanol added stirred for 20 min. The solution evaporated and obtained crude mass heated at 900° C. for 3 hr under nitrogen atmosphere.

### Fe—Mo—P

The mixture of FeSO₄, Na₂MoO₄ and NaH₂PO₂ (1:1:1 eq. wt.) ground very well in mortar. The mixture transferred into Swagelok cell heated at 500° C. for four hours. After reaction completion, cooled to room temperature and product taken out from the Swagelok cell.

### Example 5

### Determination of Ammonia Formed During Nitrogen Reduction Reaction (NRR)

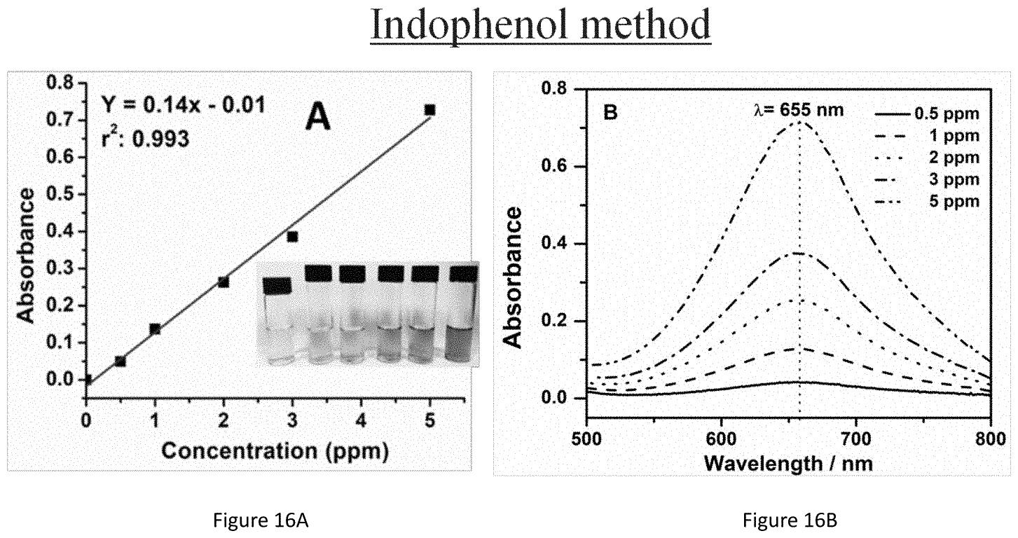

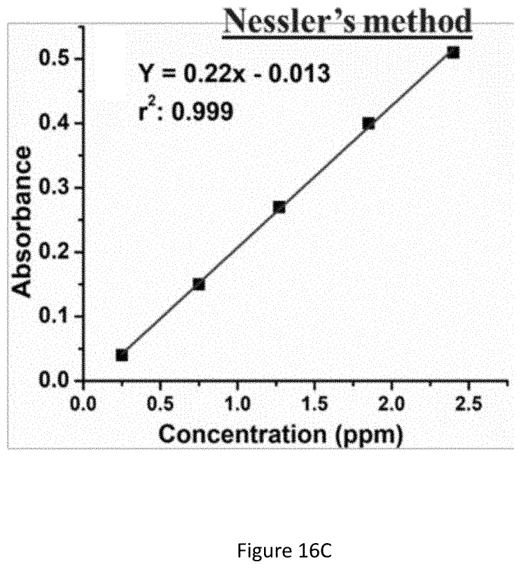

Ammonia generated during electrochemical nitrogen reduction reaction determined by using two well-known methods, namely Nessler's reagent method and indophenol chemical method (FIG. 16A-C). The Nessler's reagent method is very simple and fast way to detect/determine the presence of ammonia. It is ready to use reagent (0.09 mol/L solution of potassium tetraiodomercurate(II) (K₂[HgI₄]) in 2.5 mol/L potassium hydroxide) prepared from aqueous solution of mercuric iodide and potassium iodide. This reagent reacts with ammonia and gives yellow color due to formation of iodide of Millon's base as shown in below reaction.

NH₄⁺+2 [HgI₄]²⁻+4 OH⁻→HgO.Hg(NH₂)I (iodide of Millon's base)+7 I⁻+3 H₂O

In Indophenol chemical method, ammonia reacts in moderately alkaline solution with hypochlorite to give monochloramine which, in the presence of phenol, catalytic amounts of nitroprusside ions and excess of hypochlorite gives indophenol blue as shown in reaction below. Since it is chemical reaction, minimum 2 h needed for the completion before quantification of ammonia using UV-Vis spectroscopy.

### Example 6

### RuₓSn_{y} Bimetallic Nanoparticles on Carbon Support for Nitrogen Reduction Reaction to Ammonia

### Synthesis of RuSn_{y} Alloy Catalyst

Solvothermal procedure has been used for the synthesis of RuₓSn_{y} particles supported on high active surface area carbon support. The calculated amount of ruthenium (III) chloride hydrate (Ru content: 42.28 wt %) and tin(II) chloride has been mixed with the 63 mg of Vulcan Carbon Support® and an excessive amount of the reducing agent (i.e. ethylene-glycol). The so-obtained mixture was sonicated for 20 min. and vigorously stirred for 3 h in order to homogenize the system. To that mixture, 9 ml of absolute ethanol is added, and argon was purged for 20 minutes to displace the dissolved oxygen. The argon saturated solution is transferred into a Teflon lined autoclave heated up to 200° C. for 9.5 h. Once the mixture is cooled to room temperature, the ethylene glycol was separated by centrifugation and the crude solid product is washed 5 times with absolute ethanol. Following the washing cycles, the RuₓSn_{y}/C samples were dried in the vacuum oven at 60° C. for 1 h with an additional drying cycle at 80° C. and atmospheric pressure. Ru/C is synthesized in the same way as RuₓSn_{y}/C while the Sn/C required additional reduction step in hydrogen-argon atmosphere (20%-80% v/v) at 400° C. for 2 h to reduce the formed SnO₂/C nanoparticles into its metallic Sn form.

### Results

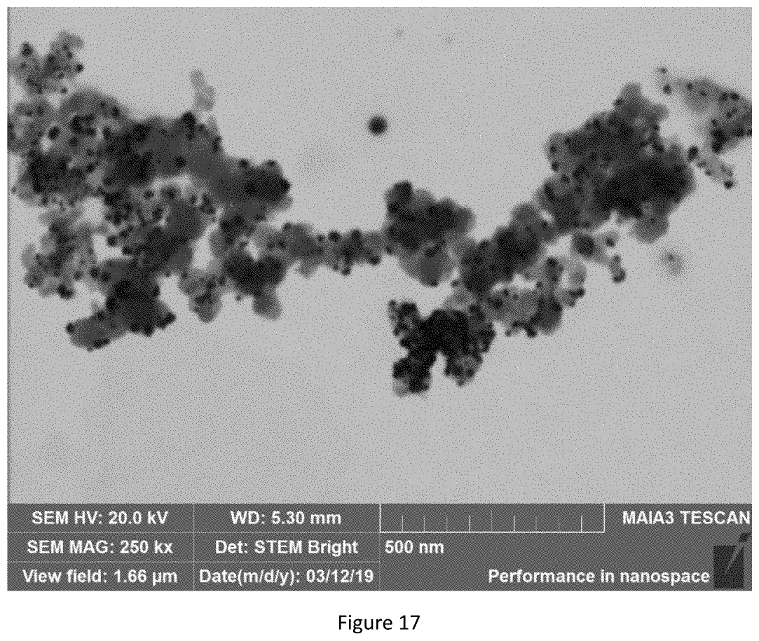

The morphology of nanoparticles and their average size have been determined by STEM imaging on the copper grid. FIG. 17 presents the STEM images of RuSn/C samples. The image shows spherical RuSn nanoparticles, with a size distribution ranging from 3-15 nm, are attached to the surface of the carbon support used in the synthesis of the catalyst.

Linear Sweep Voltammetry (LSV) and chronoamperometry have been used to examine the electrocatalytic properties of RuₓSn_{y} catalyst.

Choice N #1 (Rate Expressed as mol s⁻¹ mg⁻²)

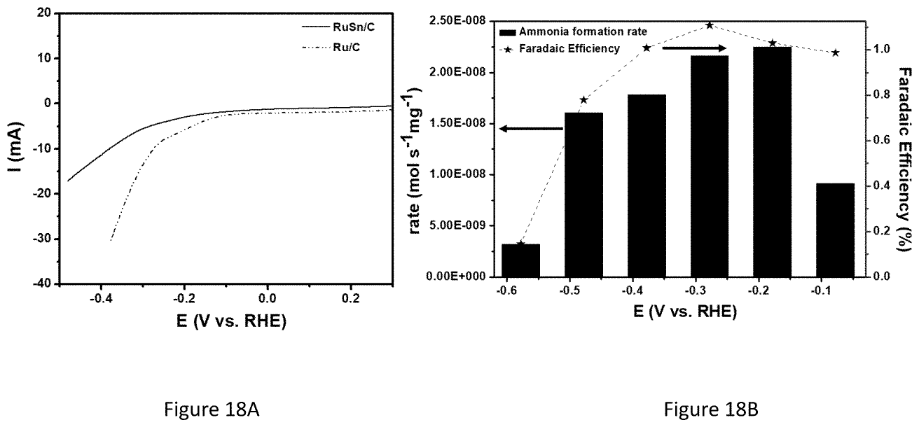

FIG. 18A presents the LSV of the Ru/C and RuSn/C (50% each metal) recorded in nitrogen saturated 0.1M Na₂SO₄. The significant shift in an HER (and concomitant NRR) overpotential of ca. 100 mV has been noticed as expected for the alloys that contain the HER “resistant” elements such as Sn. Although the total catalyst loading, i.e. RuSn/C along with Nafion binder, in both cases was similar (2.2 mg for RuSn/C and 2.4 mg for Ru/C), significant decrease in current can be noticed. This can be ascribed to impeded HER on this type of catalysts.

Ammonia formation rates and Faradaic efficiencies are calculated from chronoamperometric curves, recorded in a nitrogen saturated atmosphere and a constant potential during the period of 2 h. The optimal rate optimization and corresponding Faradaic efficiencies are shown in FIG. 18B. The highest ammonia formation rate of 2.25×10⁻⁸ mol ‘mg’ was achieved at −200 mV (vs RHE) with Faradaic efficiency of ca. 1%. In FIG. 2A, the appearance of HER (appears negative currents) are delayed by 100 200 mV, allowing in RuSn at higher efficiency.

Choice N #2 (Rate Expressed as mol s⁻¹cm⁻²)

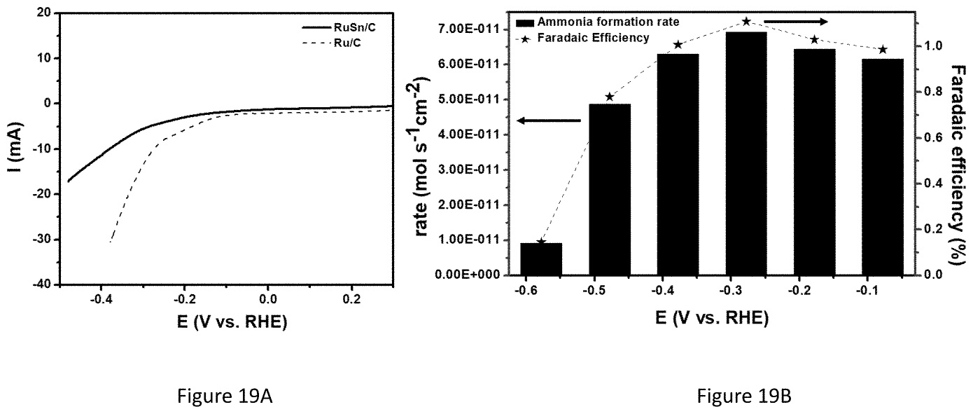

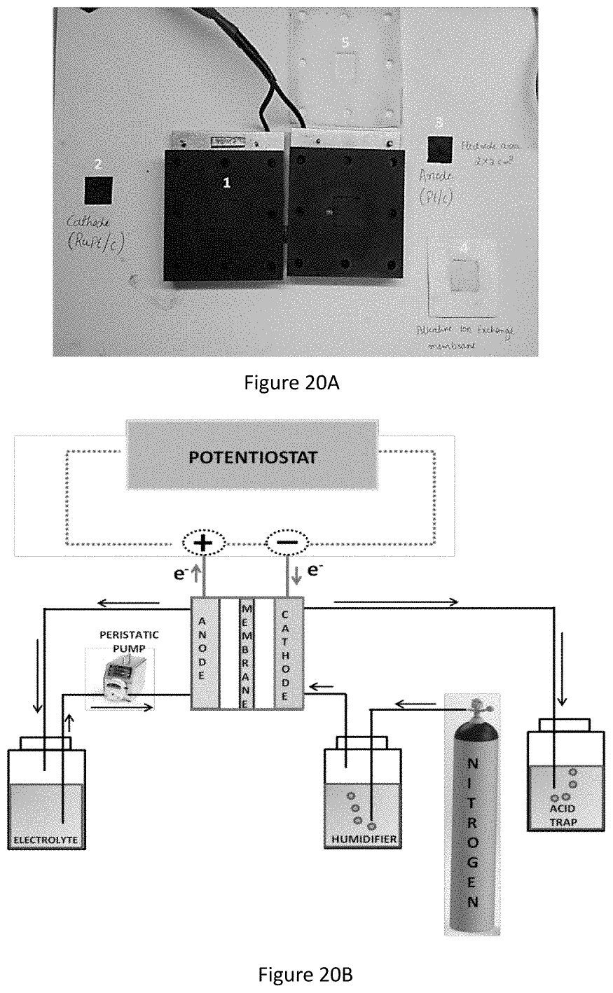

FIG. 19A presents the LSV of the Ru/C and RuSn/C (50% each metal) recorded in nitrogen saturated 0.1M Na₂SO₄. The significant shift in an HER (and concomitant NRR) overpotential of ca. 100 mV has been noticed as expected for the alloys that contain the HER “resistant” elements such as Sn. Although the total catalyst loading, i.e. RuSn/C along with Nafion binder, in both cases was similar (2.2 mg for RuSn/C and 2.4 mg for Ru/C), significant decrease in current can be noticed. This can be ascribed to impeded HER on this type of catalysts.

The optimal rate optimization and corresponding Faradaic efficiencies are shown in FIG. 19B. The highest ammonia formation rate of 6.93×10⁻¹¹ mol s⁻¹ mg⁻¹ was achieved at −200 mV (vs RHE) with Faradaic efficiency of ca. 1.1%.

### Example 7

### Catalyst Development Generation 1

The various commercially available/synthesized catalysts were tested for electrochemical ammonia synthesis. The obtained results are tabulated in Table 5. Among all the catalysts tested, as prepared Fe₂O₃/TiO₂ via simple precipitation followed by hydrothermal method showed better ammonia production.

TABLE 5

| | | Rate of ammonia |
|---|---|---|
| | Temperature | production, |
| Catalyst composition | in cell/° C. | mol s⁻¹cm⁻² |
| Ru@Fe/Fe₂O₃^{†} | 50 | 2 × 10⁻¹⁰ |
| Titanium powder^{‡} | 50 | 2 × 10⁻¹⁰ |
| Titanium nanoparticles^{‡} | 50 | 4.5 × 10 ⁻¹¹ |
| Titanium hydride^{‡} | 50 | 6 × 10⁻¹¹ |
| CFeMOBi^{†} | 50 | 3.5 × 10⁻¹¹ |
| RuPt^{‡} | 50 | 3.5 × 10⁻¹⁰ |
| RuPt—TiPowder^{†} | 50 | 2.2 × 10⁻¹⁰ |
| Ti—Phthalocyanine ^{‡} | 50 | 0.5 × 10⁻¹⁰ |
| Fe—Mo—P^{†} | 50 | Not active catalyst for |
| | | ammonia production |
| Commercial Pt ^{‡} | 50 | Not active catalyst for |
| | | ammonia production |
| Commercial Pd ^{‡} | 50 | Not active catalyst for |
| | | ammonia production |
| Commercial Ru ^{‡} | 50 | 1.0 × 10⁻¹¹ |
| RuPt ^{‡} | RT | 8.1 × 10⁻¹¹ |
| RuPt/C ^{‡} | 50 | (5 ± 1) × 10⁻¹⁰ |
| Ru/TiO₂—Ti₂O₃^{†} | 50 | (9.3 ± 1) × 10⁻¹⁰ |
| Fe₂O₃/TiO₂/C*† | 50 | (1 ± 0.5) × 10⁻⁸** |

^{†}Synthesized catalyst,
^{‡}commercially available catalyst
**attained using ~100 mg cm⁻² of this low-cost material

The best catalyst for electrochemical ammonia synthesis is the synthesized Fe₂O₃/TiO₂/C. The rate of ammonia produced with this catalyst is ˜17×10⁻⁸ g/cm²s=1×10⁻⁸ mol s⁻¹cm⁻² with columbic efficiency 5±1%.

It is important to note that the Fe₂O₃/TiO₂/C is a very low cost material, the synthesis method requires soft conditions of temperature and pressure and can be easily upscaled.

The rate of ammonia formation depends on the temperature and strength of KOH. The cell temperature up to 50° C. and 5.0 M KOH (as an electrolyte) leads higher yield of ammonia. For instance, at room temperature rate of ammonia formed in the order of (4±1)×10⁻⁹ on the other hand at 50° C. rate of ammonia formation has been increased up to (1±0.5)×10⁻⁸ mol s⁻¹ cm⁻².

### Example 8

### Electrochemical Ammonia Generator Prototypes

Three types of electrochemical ammonia generators were fabricated and tested. The fabrication and testing protocols are given below.

### Generator 1 Prototype

Fuel cell configuration consisting of two electrodes electrochemical generator. Membrane electrode assembly (MEA) is designed to work in a fuel cell configuration. The MEA has been prepared by sandwiching cathode electrode (catalyst coated Toray carbon 4 cm⁻²) and anode (Pt/C coated Toray carbon 4 cm⁻²) and alkaline membrane (quaternary ammonium polysulfone, 40 μm thickness) between them. On cathode side, high purity nitrogen (99.999) has been introduced and on the other anode side 1.0 M KOH has been continuously circulated (5 ml/min.) by using peristaltic pump. Above mentioned procedure is followed to determine the quantity of ammonia produced during the electrochemical reaction.

### Fuel Cell Configuration

### Operation of Prototype 1

In this prototype, the nitrogen reduction reaction catalyst and electrolyte oxidizing catalyst were used as cathode and anode respectively. Anionic membrane sandwiched between anode and cathode. The known quantity of humidified nitrogen was passed through gas diffusion layer coated with catalyst and 1.0 M KOH electrolyte continuously circulated to the anode by using peristaltic pump. At an applied potential, nitrogen gas reduced to ammonia at cathode (as shown in equation 4) and was trapped in 10 mM H₂SO₄ for the quantification. On the other hand, at anode electrolyte oxidized to oxygen as shown in equation 5. The overall net reaction is given below.

Cathode: N₂+6H₂O+6e⁻→2NH₃+6OH⁻ (4)

Anode: 6OH⁻6H⁺→3H₂O+1.50₂ (5)

Net reaction: N₂+6H⁺+6e⁻→2NH₃+1.50₂ (6)

### Current Produced Under Static and Dynamic Potential Control

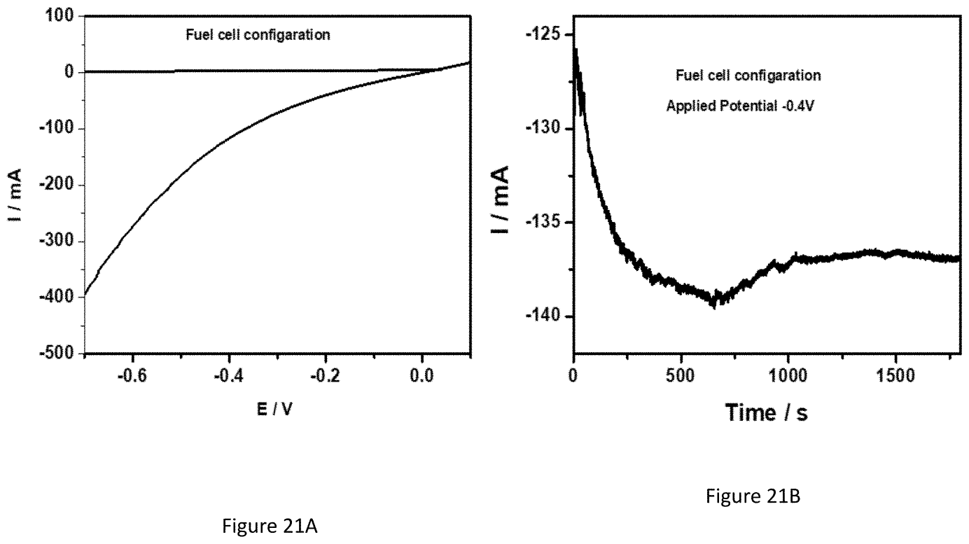

Linear sweep voltammogram (LSV) of nickel foil anode-alkaline membrane-Fe₂O₃/TiO₂ composite-cathode fuel cell type prototype configuration under nitrogen gas atmosphere is depicts in FIG. 21A. This configuration produces very high currents, due to the low ohmic resistance of the electrolyte membrane/separator.

The obtained results are given table 6.

TABLE 6
Electrochemical ammonia synthesis in fuel cell
configuration at various applied potentials.

| | Applied | Ammonia formation/ |
|---|---|---|
| Sl. no. | voltage/V | mol s⁻¹cm⁻² |
| 1 | −0.4 | 7 × 10⁻¹⁰ |
| 2 | −1.3 | 8.2 × 10⁻¹⁰ |
| 3 | −1.5 | 1.6 × 10⁻¹⁰ |
| 4 | −1.7 | 3.2 × 10⁻¹⁰ |

Due to unavailability of robust, durable and stable alkaline exchange membrane, electrochemical ammonia synthesis by fuel cell configuration has discontinued.

### Bottle Cell Configuration—Prototype 2

In this configuration, membrane is not used for separation of anode and cathode parts of cell. The cell consists of detachable plastic vessel and rubber cork. Cathode part of cell is the vessel (bottle or glass) that include:

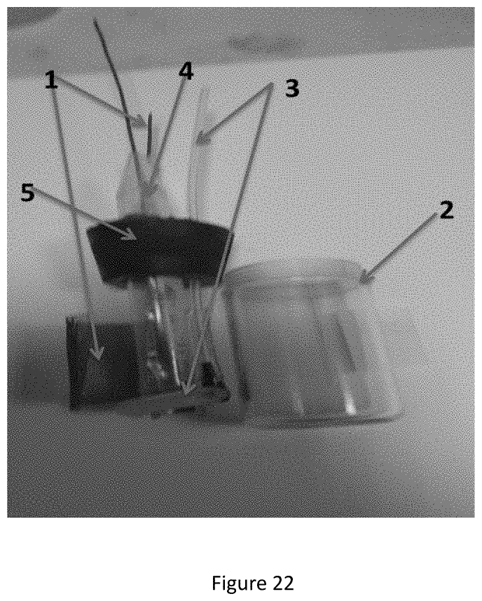

The working electrode (1 on FIG. 22) that can be a free form and that placed in vessel. The nitrogen gas is purged nearby working electrode (3 on FIG. 22) by silicon tubing with holes for nitrogen bubbling and immersed in electrolyte; the produced ammonia gas at the working electrode come out in silicon tubing and trapped in diluted acid.

Anode part of cell is plastic tube that fit in vessel and include anode (Ni foil).

Connection between cathode and anode parts of cell carried out by electrolyte in bottom part.

Results

The electrochemical experiments carried out for electrochemical ammonia synthesis using Fe₂O₃/TiO₂/C catalyst in bottle cell configuration at room temperature and 50° C. using a 4.9 cm2 size electrode. Ammonia formation rate determined by chronoamperograms of Fe₂TiO₃/TiO₂/C electrodes at an applied potential of −1.8 V at room temperature and 50° C. the results is tabulated in table 7.

TABLE 7
The electrochemical ammonia formation at Fe₂TiO₃/TiO₂/C electrodes at RT and
50° C.

| | | | | Quantification of | | Ammonia | |
|---|---|---|---|---|---|---|---|
| | | | Current | ammonia using | | formation | Efficiency |
| | | | observed in | Indophenol/ | | (Experimental) | of |
| | | Potential | CA | mol s⁻¹cm⁻² (acid | Ammonia | (Based on | ammonia |
| | Time/ | applied/ | experiment/ | trap and alkaline | formation | Indophenol | produced/ |
| No. | min. | V | mA/cm² | solution) | (Theoretical) | method) | % |
| 1 | 60 | −1.8 | 50 (6.5 | 5.4 × 10⁻⁹ | 10.4 mg | 0.330 mg | 3.2 |
| | | | cm²) | | | | |
| 2 | 30 | | 75 (6.5 | 5.9 × 10⁻⁹ | 15.6 mg | 0.361 mg | 2.4 |
| | | | cm²) | | | | |
| 3 | 30 | | 60 (4.9 | 1.05 × 10⁻⁸ | 12.48 mg | 0.642 mg | 5.1 |
| | (50° C.) | | cm²) | | | | |
| 4 | 30 | | 75 (4.9 | 1.1 × 10⁻⁸ | 15.6 mg | 0.673 mg | 4.3 |
| | (50° C.) | | cm²) | | | | |

The rate of electrochemical nitrogen reduction reaction of Fe₂TiO₃/TiO₂/C (4.9 cm²) electrodes at 50° C. in two electrode system were found to be 1.05×10⁻⁸ and 1.1×10⁻⁸ mol s⁻¹cm⁻² with faradaic efficiencies 5.1 and 4.3.

Electrochemical Cell without Membrane—Prototype 3

### Working Procedure

In this setup nitrogen gas purged through cathode (which is mounted on porous frit covered with Teflon layer to avoid leakage of electrolyte), anode is dipped in electrolyte and separated from cathode without any membrane as shown in FIG. 23.

Ammonia dissolves in aqueous solution (−28 wt %), keeping this point in mind above electrochemical cell has been developed which can work with minimal quantity of electrolyte. As a result electrochemically generated ammonia saturates quickly in electrolyte and comes out from the cell and collects in acid trap. On the other hand, nitrogen is passing through the catalyst coated carbon felt; as a result most of the active sites are utilized for the electrochemical nitrogen reduction reaction.

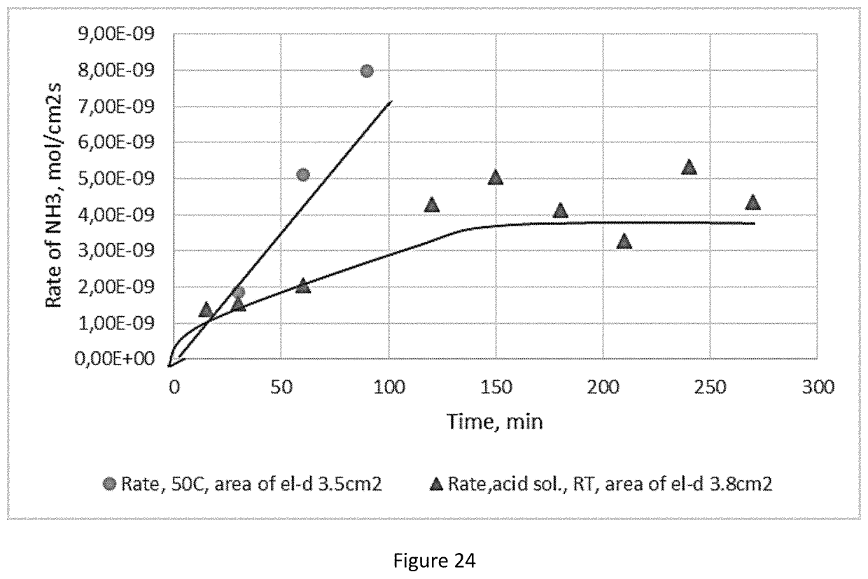

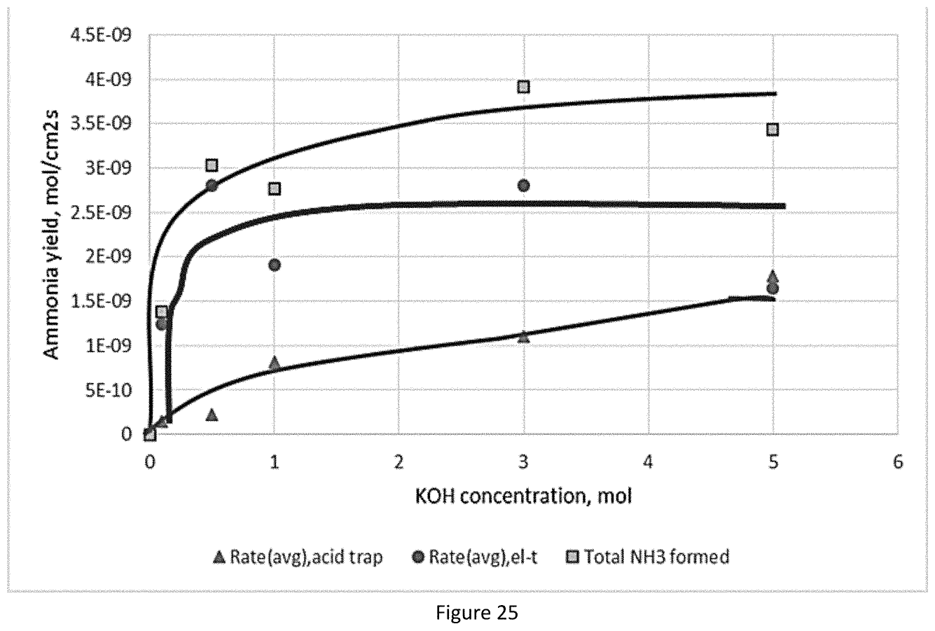

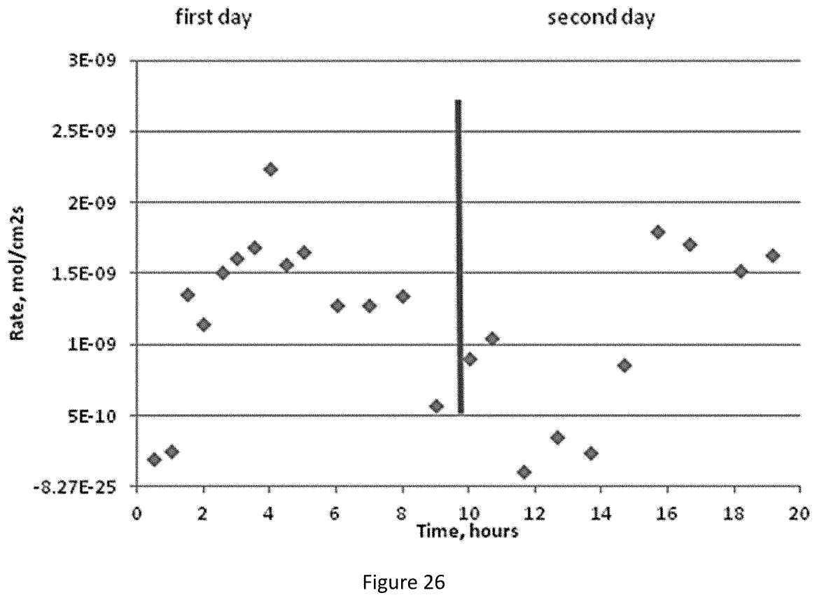

The rate of electrochemical ammonia formation at Fe₂TiO₃/TiO₂/C catalyst at room temperature and 50° C. is shown in FIG. 24. The effect of KOH concentration and stability of electrode are shown in FIGS. 25 and 26 respectively.

The ammonia formation rate is higher at 50° C. than RT. As KOH electrolyte concentration increased, the rate of ammonia formation increased. This could be due to catalyst active sites available for nitrogen reduction reaction than hydrogen evolution reaction. More importantly, Fe₂TiO₃/TiO₂/C catalyst showed sataisfactory stability as shown in FIG. 26.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A composition comprising a first metal component comprising one or more metals and a second metal component comprising one or more metals, wherein:
(i) at least one surface of said second metal component is coated with said first metal component;
(ii) the molar ratio of said first metal component to said second metal component are in the range of 1:9 to 9:1, and
(iii) said composition is in the form of particles.

2. The composition of claim 1, wherein said particles have a size in the range of 1 nm to 50 μm.

3. The composition of claim 1, wherein said first metal component and/or second metal component comprise two metals.

4. The composition of claim 1, wherein said first metal component comprises Fe, Ru, Pt, Pd, Sn, Co, Mo, and any combination thereof.

5. The composition of claim 1, wherein said second metal component comprises Ti, Sn, Ru, Fe, Pt, Pb, Bi, Hg, Cd, and any combination thereof.

6. The composition of claim 1, wherein said first metal component is Fe₂O₃ or Fe₃O₄ or Fe₂O₃FeO and wherein said second metal component is TiO₂.

7. The composition of claim 1, wherein said first metal component is Fe and wherein said second metal component is Sn.

8. The composition of claim 1, wherein said first metal component is Ru or Fe and wherein said second metal component is Pt or Pd or Sn.

9. The composition of claim 1, wherein said first metal component is Pt and wherein said second metal component is Ru.

10. The composition of claim 1, further comprising a substrate, wherein said first metal component and said second metal component are deposited on at least one surface of said substrate.

11. The composition of claim 10, wherein said substrate is selected from the group consisting of: carbon black, activated carbon, graphite, carbon nanotube, and any combination thereof.

12. The composition of claim 11, wherein said carbon black is selected from the group consisting of: carbon nanotube, graphene, Vulcan XC-72, Black Pearls 700, Black Pearls 800, Vulcan XC-605, Regal 350, Regal 250, Black Pearls 570, and Vulcan XC-68.

13. (canceled)

14. The composition of claim 10, wherein said substrate is present at a concentration of 5% to 50%, by total weight of said composition.

15. The composition of claim 1, wherein said composition is a catalyst.

16. (canceled)

17. An electrochemical cell comprising the catalyst of claim 15, wherein said catalyst is a cathode.

18. The electrochemical cell of claim 17, further comprising:
an electrolysis cell container comprising an inlet and an outlet;
a distributor, wherein said distributor is in fluid communication with said cathode and said inlet, optionally wherein said cathode, said anode or both, is at least partially porous; and
an anode, wherein:
(i) said anode and cathode are spaced apart from each other inside the container;
(ii) said anode is in electrical communication with said cathode;
(iii) the largest dimension of said anode and said cathode is defined by transverse cross-section dimensions of said electrolysis cell container; and
(iv) said cathode is at least 50 fold thicker than said anode.

19. The electrochemical cell of claim 18, wherein said container is (i) configured to allow a nitrogen gas to enter through said inlet and to contact said distributor, optionally wherein said distributor is configured to uniformly distribute said gas over a surface of said cathode, or (ii) said container is configured to allow a nitrogen gas to enter thereto and to contact said cathode.

20. (canceled)

21. (canceled)

22. (canceled)

23. The electrochemical cell of claim 17, configured to any one of: (i) electrically connect an electric potential to the anode and to the cathode; (ii) synthesize ammonia at a rate of 1×10⁻¹¹ mol s⁻¹cm⁻² to 1×10⁻⁷ mol s⁻¹cm⁻² at 1 atm N₂; (iii) synthesize ammonia at a rate of at least 1×10⁻⁹ mol cm⁻² s⁻¹ on said catalyst at 1 atm N₂; and (iv) synthesize hydrogen.

24. (canceled)

25. (canceled)

26. (canceled)

27. (canceled)

28. (canceled)

29. (canceled)

30. (canceled)

31. The electrochemical cell of claim 17, wherein said container further comprises an alkaline electrolyte solution, optionally wherein any one of: (i) said electrolyte solution is saturated with nitrogen; (ii) said alkaline electrolyte solution is a sodium hydroxide (NaOH) solution, potassium hydroxide (KOH) solution or lithium hydroxide (LiOH) solution; and (iii) said alkali electrolyte solution is present at a concentration of 0.1 to 5 M.

32. (canceled)

33. (canceled)

34. (canceled)

35. A process of synthesizing ammonia, the process comprising: (i) contacting a nitrogen gas with the cathode of the electrochemical cell claim 19, and (ii) applying an electric potential to the anode and the cathode, thereby obtaining said ammonia optionally wherein any one of: (i) said synthesis is performed at a temperature of from 20° C. to 80° C., (ii) said synthesis is characterized by a faradaic efficiency in the range of 1% to 30%; and (iii) wherein the rate of ammonia production is in the range of 1×10⁻¹¹ mol s⁻¹cm⁻² to 1×10⁻⁷ mol s⁻¹cm⁻².

36. (canceled)

37. (canceled)

38. (canceled)

39. (canceled)
